(19) United States
(12) Patent Application Publication
(10) Pub. No.: US 2020/0134976 A1
(43) Pub. Date: Apr. 30, 2020

(54) SYSTEMS FOR ADMINISTERING COMMUNITY HAND WAGERING GAMES AND RELATED METHODS

(71) Applicant: SG Gaming, Inc., Las Vegas, NV (US)

(72) Inventors: Christopher D. Wester, Henderson, NV (US); Gabriel A. Baron, Henderson, NV (US); Bradley David Kendall, Toongabbie (AU)

(21) Appl. No.: 16/726,610

(22) Filed: Dec. 24, 2019

Related U.S. Application Data
(63) Continuation of application No. 15/590,896, filed on May 9, 2017.

(51) Int. Cl. G07F 17/32

(52) U.S. Cl. CPC G07F 17/3288; G07F 17/3248; G07F 17/3246; G07F 17/322; G07F 17/3218; G07F 17/3209; G07F 17/3293

(57) ABSTRACT

Methods of administering wagering games include administering an opportunity for at least one player to place at least one ante wager on at least one community hand. Methods of administering such wagering games may be performed over a network utilizing a processor.

### CROSS-REFERENCE TO RELATED APPLICATION

This application is a continuation of U.S. patent application Ser. No. 15/590,896, filed May 9, 2017, pending, the disclosure of which is hereby incorporated herein in its entirety by this reference.

### TECHNICAL FIELD

This disclosure relates generally to methods of administering wagering games for casinos and other gaming establishments, and related systems and apparatuses. More specifically, disclosed embodiments relate to systems for and methods of administering wagering games (e.g., a single card poker hand type or other high card type wagering games) including one or more community hands upon which one or more players may place a wager.

### BACKGROUND

Wagering games based on the outcome of randomly generated or randomly selected symbols are well known. Such games are widely played in gaming establishments such as casinos. The wagering games include card games, wherein the symbols comprise familiar, common playing cards. Card games such as twenty-one (also known as “blackjack”), poker, variations of poker, high card games (e.g., CASINO WAR®), and the like are excellent card games for use in casinos. Desirable attributes of casino card games are that the games are exciting, they can be learned and understood easily by players, and they move or are played rapidly to a wager-resolving outcome.

Game administrators, such as casinos or other gaming establishments, frequently seek new games to offer to their clientele. Such games are often administered with one or more players playing against a dealer (who may also act as the banker) provided by the game administrator. Alternatively, the games may be administered with players playing against each other. In “card room” games, each player may have the option to act as a banker, while the gaming establishment administers the game and takes fees from the players.

Players typically enjoy games that can be played rapidly and that offer players a choice. Such choices may heighten player interest in games.

U.S. Pat. No. 5,324,041 (Boylan et al.), issued Jun. 28, 1994, the disclosure of which is incorporated herein in its entirety by this reference, describes a casino game that is a variant of the conventional parlor game called “War.” In this game, the dealer deals one card, face up, to each of the players as well as a face up card to themselves. Taking each player in turn, the dealer determines whether the numerical value (i.e., rank) of the card of the player is greater than, less than, or equal to the rank of the dealer's card. If the value of the card of the player is less than or equal to that of the dealer, the player loses an ante bet which is immediately collected from the area by the dealer. If the value of the card of the player is greater than that of the dealer, the player wins and the dealer immediately pays the player an amount, such as, an amount equal to the ante bet of that player. If the value of the card of the player and dealer are equal, additional cards may be dealt to each of the player and the dealer. In this scenario, the player may make an additional tie bet on the additional cards dealt.

Accordingly, conventional wagering games, including conventional high card-type and War-type games, conventionally involve each player playing one hand against a live or virtual dealer. However, additional wagering features and choices in such games enhance player interest in the game and provide more profits for the establishment offering such games.

### BRIEF SUMMARY

In some embodiments, the present disclosure includes a method of administering a wagering game. The method includes providing a processor programmed to enable one or more players to place ante wagers at some or all of a plurality of community hand positions; receiving, at the processor, an indication that at least one ante wager on a community hand position of the plurality of community hand positions to participate in the wagering game is accepted from a player; receiving, at the processor, an indication of at least one of the plurality of community hand positions associated with the at least one ante wager; determining, with the processor, a plurality of active community hand positions on which at least one wager has been received, the plurality of active community hand positions each exhibiting at least one randomized playing card from a set of playing cards; determining, with the processor, a dealer hand position, the dealer hand position exhibiting at least one randomized playing card from the set of playing cards; comparing a highest ranking playing card of each active community hand position of the plurality of active community hand positions with a highest ranking playing card of the dealer hand position; and resolving, with the processor, the at least one ante wager based on the comparison of the highest ranking card of the dealer hand position to the highest ranking card of at least one active community hand position of the plurality of active community hand positions.

In additional embodiments, the present disclosure includes a method of administering a wagering game. The method includes providing a processor programmed to enable at least one player to place at least one ante wager at a plurality of community hand positions; receiving, at the processor, an indication that the at least one ante wager to participate in the wagering game is accepted from at least one player; receiving, at the processor, an indication of at least one of a plurality of community hand positions associated with the at least one ante wager from the at least one player; dealing each of the plurality of community hand positions one physical playing card from a set of physical playing cards; dealing the dealer hand position one physical playing card from the set of physical playing cards; comparing the one physical playing card of each community hand of the plurality of community hand positions with the one physical playing card of the dealer hand position; resolving, at the processor, the at least one ante wager based on the comparison of the one physical playing card of the dealer hand position to the one physical playing card of each community hand of the plurality of community hand positions; determining if the one physical playing card of the dealer hand position and the one physical playing card of at least one community hand of the plurality of community hand positions are equal; if the one physical playing card of the dealer hand position and the one physical playing card of at least one community hand of the plurality of community hand positions are equal, providing, at the processor, the at least one player an opportunity to place an additional tie bet; providing each of the dealer hand position and the least one community hand that is equal to the dealer hand position one additional physical playing card; comparing the one additional physical playing card of the at least one community hand of the plurality of community hand positions with the one additional physical playing card of the dealer hand position; and resolving, with the processor, the additional tie bet based on the comparison of the one additional physical playing card of the dealer hand position to the one additional physical playing card of the at least one community hand of the plurality of community hand positions.

In yet additional embodiments, the present disclosure includes a method of administering a wagering game over a network utilizing a processor. The method comprising: providing a processor programmed to enable a plurality of players to place a plurality of ante wagers at some or all of a plurality of community hand positions; receiving, at the processor, an indication that the plurality of ante wagers to participate in the wagering game is accepted from the plurality of players; receiving, at the processor, an indication of at least one of a plurality of community hand positions associated with each ante wager of the plurality of ante wagers from the plurality of players; dealing each of the plurality of community hand positions at least one physical playing card from a set of physical playing cards; dealing the dealer hand position at least one physical playing card from the set of physical playing cards; comparing the at least one physical playing card of each community hand of the plurality of community hand positions with the at least one physical playing card of the dealer hand position; and resolving, with the processor, the plurality of ante wagers based on the comparison of the at least one physical playing card of the dealer hand position to the at least one physical playing card of each community hand of the plurality of community hand positions.

Yet other embodiments may comprise apparatuses and systems for administering wagering games according to embodiments of the disclosure.

### BRIEF DESCRIPTION OF THE DRAWINGS

While this disclosure concludes with claims particularly pointing out and distinctly claiming specific embodiments, various features and advantages of embodiments within the scope of this disclosure may be more readily ascertained from the following description when read in conjunction with the accompanying drawings, in which:

FIG. 1 is a flowchart diagram of a method of administering a wagering game, according to an embodiment of this disclosure;

FIG. 2 is a diagram of a playing surface for implementation of a method of administering a wagering game, according to an embodiment of this disclosure;

FIG. 3 is an enlarged diagram of a player position of the playing surface of FIG. 2;

FIG. 4 is a perspective view of a gaming table configured for implementation of embodiments of wagering games in accordance with this disclosure;

FIG. 5 is a perspective view of an individual electronic gaming device configured for implementation of embodiments of wagering games in accordance with this disclosure;

FIG. 6 is a top view of an electronic table configured for implementation of embodiments of wagering games in accordance with this disclosure;

FIG. 7 is a perspective view of another embodiment of an electronic table configured for implementation of embodiments of wagering games in accordance with this disclosure, wherein the implementation includes a virtual dealer;

FIG. 8 is a schematic block diagram of a gaming system for implementing embodiments of wagering games in accordance with this disclosure;

FIG. 9 is a schematic block diagram of a gaming system for implementing embodiments of wagering games including a live dealer feed; and

FIG. 10 is a block diagram of a computer for acting as a gaming system for implementing embodiments of wagering games in accordance with this disclosure.

### DETAILED DESCRIPTION

The illustrations presented in this disclosure are not meant to be actual views of any particular act in a method, apparatus, system, or component thereof, but are merely idealized representations employed to describe illustrative embodiments. Thus, the drawings are not necessarily to scale. Additionally, elements common between figures may retain the same or similar numerical designation. Elements with the same number, but including a different alphabet character as a suffix should be considered as multiple instantiations of substantially similar elements and may be referred generically without an alphabet character suffix.

The terms “gaming,” “gambling,” or the like, refer to activities, games, sessions, rounds, hands, rolls, operations, and other events related to wagering games the outcome of which is at least partially based on one or more random events (“chance” or “chances”), and on which wagers may be placed by a player. In addition, the words “wager,” “bet,” “bid,” or the like, refer to any type of wager, bet, or gaming venture that is placed on random events, whether of monetary or non-monetary value. Points, credits, and other items of value may be purchased, earned, or otherwise issued prior to beginning the wagering game. In some embodiments, purchased points, credits, or other items of value may have an exchange rate that is not one-to-one to the currency used by the user. For example, a wager may include money, points, credits, symbols, or other items that may have some value related to a wagering game. Wagers may be placed in wagering games that involve the risk of real-world monetary value for the potential of payouts with real-world monetary value (e.g., the “play-for-pay,” such as “house-banked” and “player-banked” configurations, each of which is described in more detail below) or in wagering games that involve no real-world monetary risks for the player (e.g., the “play-for-fun” and “social play-for-fun” configurations described in more detail below).

As used herein, the term “wager” includes any form of wagering value, including money, casino chips, other physical means for payment, and online or remote electronic authorization of a wager in any acceptable form to the casino or online or virtual game host. Also included are physical representations of money (e.g., casino chips) at a local game, as well as virtual representations of money in the form of electronic authorizations of a transfer of money and digital representations of money (e.g., digital representations of bills or coins, digital representations of chips, numerical quantities of money, numerical quantities of points, or numerical quantities of credits) at a local or remote electronic gaming device. As used herein, the term “wagering element” means and includes objects and symbols used to signify the acceptance of a wager. For example, physical wagering elements include physical money (e.g., bills and coins) and physical wagering tokens (e.g., poker chips), which may or may not be redeemable for monetary value and may or may not include electronic identifiers (e.g., RFID chips) embedded within the tokens, enabling electronic sensing and tracking of wagering. Virtual wagering elements include, for example, images (e.g., images of money or poker chips) and text (e.g., a string of numbers), which may or may not be redeemable for monetary value. In the “play-for-fun” and “social play-for-fun” configurations, a “wager” may not have a cash value (i.e., a real-world monetary value).

For the purposes of this description, it will be understood that when an action related to accepting wagers, making payouts, dealing cards, selecting cards, or other actions associated with a player or a dealer is described herein, and such description includes a player or a dealer taking the action, the results of the action may be computer generated and may be displayed on a live or virtual table or electronic display, and, if applicable, the reception or detection of such an action in an electronic form where player and dealer choices, selections, or other actions are received at an electronic interface. This further includes the results of a virtual dealer and virtual players, where the actions described are actually generated by a computer (typically associated with an online game). By way of a further example, if dealing of a card is described herein, the description includes (but is not limited to) the following: the dealing of a card by a dealer from a deck, set of cards (e.g., including one or more full or partial decks of cards), shuffler, shoe, or other card source and the reception or placement of the card at a table location associated with a player or reception directly by a player; the generation and transmission of an electronic indication or representation of a card from a game play source or server to an electronic receiver, where the receiver may be at a table (using virtual cards) including players and/or virtual players and/or a dealer or virtual dealer, on a gaming terminal, at a public display in a casino, at a remote location (e.g., using online or Internet game play), or at other locations. Also included is the representation of a card on a display or displays, and, if applicable to the action described, an electronic reception of an indication that the card has been received, selected, or otherwise interacted with at a location associated with a player, or, associated with a virtual player. In addition, dealing of a card may refer to revealing a representation of a card on a scratch-off card (also referred to as “scratchers”).

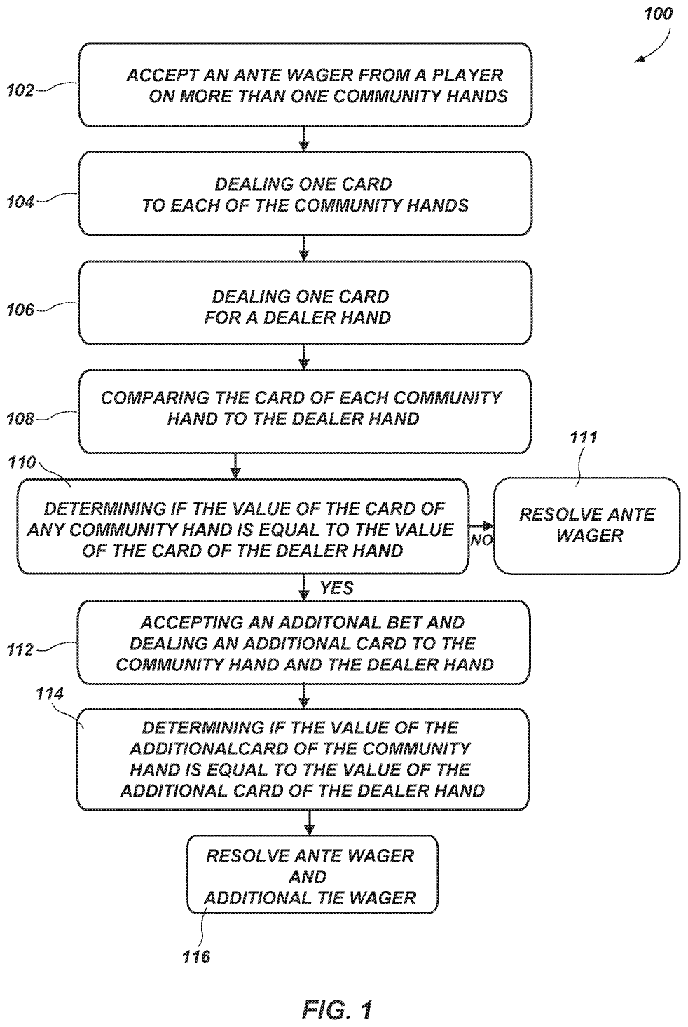

Referring to FIG. 1, a flowchart diagram of a method 100 of administering a wagering game is shown. Generally, the method 100 includes administering a wagering game including dealing a predetermined number of cards to a number of hands (e.g., one card, more than one cards). The number of hands may include one or more community hands that may be wagered on by one or more players participating in the game. As used herein, the term “community hand” means a hand that is not specific to an individual player, and which may be wagered on by only one player, or by a number of players. The community hand positions may be each be designated for play, to become active community hand positions, by placement of a wager thereon by any player participating in the wagering game and may not be assigned to any one player. For example, the community hand positions may not be assigned to any particular player, but are available for any participating player to place a wager on. Each participating player may elect to play one, some, or all of the community hand positions to which cards may be dealt by placement of associated wagers thereon. In some embodiments, the gaming establishment may select the number of community hand positions to be offered for play by the players in each game. For example, the number of community hand positions selected to be offered for play by each player may be selected as three hand positions, five hand positions, seven hand positions, more than seven hand positions, or variations therebetween. In some embodiments, the community hand positions may be dealt a card regardless of whether an ante wager was placed on the hand.

The number of hands in play of a round of the game may also include one or more hands with which the cards of the community hands are compared and evaluated (e.g., a dealer hand). In some embodiments, the community hands at each active community hand position may be compared and evaluated against each other.

In some embodiments, the wagering game may comprise a high card game (e.g., CASINO WAR®) where one card dealt to each community hand is compared to one card dealt to another hand (e.g., the dealer hand). Each participating player who placed one or more wagers on the community hands may participate in the wagering game. For example, each participating player may place an ante wager on one or more of the community hand positions as indicated in act 102. In some embodiments, a set amount of time may be provided to the players to place wagers on the community hand positions. For example, the wagering game may include a betting clock that indicates the amount of time left for making bets and indicates when that time has expired.

After the ante wagers have been placed, each hand may be dealt to each active community hand position on which an ante wager has been placed. For example, as indicated in acts 104 and 106, a predetermined number of cards (e.g., one card) may be dealt to a dealer hand position and to one or more active community hand positions. In some embodiments, cards to the community hand position and/or the dealer hand position may be dealt face up.

As indicated in act 108, the value (e.g., numerical value or rank) of the card of each community hand is compared to the value of the card of the dealer hand. As indicated in act 110, it is determined whether the value of the one card of each community hand is greater than, less than, or equal to the value of the one card of the dealer hand. As indicated in act 111, if the value of the card of a community hand and dealer hand are not equal, the ante wager is resolved as follows. If the value of the card of a community hand is less than the card of the dealer, the player loses the ante bet on that community hand and the ante bet is collected by the dealer. If the value of the card of a community hand is greater than that of the dealer, the player wins and the dealer pays the player an amount, such as, an amount equal to (e.g., 1:1) the ante bet of that player on that community hand.

As indicated in act 112, if the value of the card of a community hand and dealer hand are equal, additional cards may be dealt to each of the community hand and the dealer hand that are tied (e.g., one additional card to each tied hand). In some embodiments, the player may lose the ante bet when the value of the cards of the community hand and dealer hand are equal. In some embodiments, the dealer may return the ante bet to the player (i.e., push) when the value of the cards of the community hand and dealer hand are equal. In this tie scenario, the player may make an additional tie bet on the additional card dealt to the community hand that is tied with the dealer hand. In some embodiments, a player may only bet on a tied community hand on which the player has placed an ante wager. In some embodiments, any player may bet on any community hand that is equal to the dealer hand. In some embodiments, the player may surrender and fold and may lose all or part of (e.g., half) the ante bet, if applicable, on that community hand if the player does not wish to make the additional tie bet.

In some embodiments, the dealer may receive only one additional card regardless of how many community hands have tied with the dealer hand. In some embodiments, the dealer may receive one additional card corresponding to each community hand that has tied the dealer hand where each such additional card is played against one respective community hand. In some embodiments, the dealer may burn one or more cards before dealing the additional cards. For example, the dealer may burn three cards before each additional card is dealt.

As indicated in act 114, it is determined whether the value of the additional card of each community hand that has received an additional card is greater than, less than, or equal to the value of additional card of the dealer hand.

As indicated in act 116, the additional tie wager is resolved as follows. If the value of the additional card of the community hand is less than the value of the additional card of the dealer, the player loses the additional tie bet on that community hand and the additional tie bet is collected by the dealer. If the value of the additional card of the community hand is greater than that of the dealer, the player wins and the dealer pays the player an amount, such as, an amount equal to (e.g., 1:1) the additional tie bet of that player on that community hand.

In some embodiments, when the tie wagers 116 are resolved, so are the ante wagers. Typically, the ante wager and the tie wagers both pay 1:1 when the player hand outranks the dealer hand in a tiebreaker event.

If the value of the additional card of the community hand and the additional dealer hand are equal again, such a second tie between a community hand and the dealer hand may result in game ending event where either the additional tie bet is retained by the house, is returned the player, or the player wins a set amount on the bet. For example, the dealer may return the ante wager to the player and pay the player on the additional tie wager. In some embodiments, the dealer may pay the player an additional amount in the event of a second tie (e.g., an amount equal to the ante).

In additional embodiments, if the value of the additional card of the community hand and the additional dealer hand are equal again, yet additional cards may be dealt to each of the community hand and the dealer hand that are tied and the player may make another additional tie bet on the additional cards dealt to the community hand and the dealer hand. Act 112 is then repeated until the high card of the community hand differs from the high card of the dealer hand.

Stated in another way, once a tie occurs, the acts 110, 112, and 114 are repeated, as necessary, until the high card of the community hand differs from the high card of the dealer hand such that a determination of whether to pay the player on the additional bet or bets may be made.

In some embodiments, in addition to or as an alternative to betting only on the community hands, a player may be allowed to place an ante wager and/or an additional tie wager on the dealer hand.

As discussed above, and contrary to conventional wagering games including such a high card comparison, each player is able to bet on one or multiple hands (e.g., up to a limit set by the gaming establishment of a maximum number of active hands). For example, each player may play up to three hands, five hands, seven hands, more than seven hands, or variations therebetween. Each community hand is separate from (e.g., disassociated with) each player such that no player has the opportunity to effect the outcome of the hand. Rather, the players are only allowed to bet on one or more of the hands and the game play for each hand is dictated by the rules of the game. For example, in the high card comparison game discussed above, each community hand is played based on the rules of the games where cards are supplied to each community hand and additional cards are supplied, as necessary, in the case of tie between the community and dealer hand in a round.

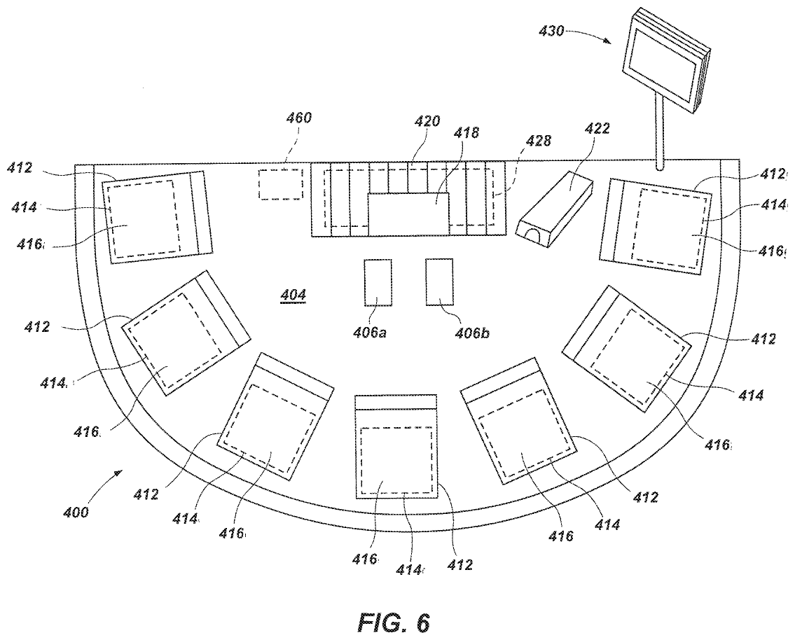

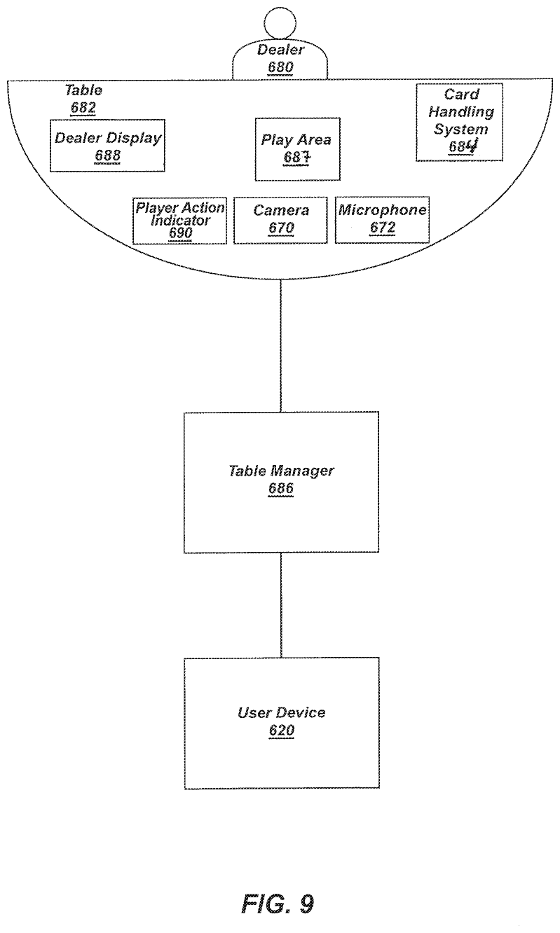

As a specific, non-limiting example, the method 100 of the wagering game may be offered and conducted on an electronic multiple player gaming systems (e.g., Bally Gaming, Inc.'s TABLE MASTER FUSION® and i-TABLE® platforms). For example, as shown in FIGS. 6 and 9 and discussed below in greater detail, the wagering game method 100 may be implemented with a live dealer that provides physical cards for the each of the community hands. In some embodiments, and detailed blow with regard to FIG. 9, the live dealer may be broadcast to at least some of the players via a live dealer feed. Such a live feed may be presented on a display in front of a number of players. In some embodiments, the display may also include games statistics, such as, for example, the number of rounds since a certain event (e.g., a community hand beating the dealer hand after a tie), the number of ties in a selected number of hands (e.g., in one hundred hands), etc. Such a configuration may enable numerous (e.g., tens, hundreds, or more) players to participate in a single game administered by the dealer.

Wagering on each of the community hands may be performed, for example, virtually through the use of player stations. In some embodiments, and also discussed herein, the wagering may be performed with physical gaming tokens or chips.

In some embodiments, a camera may be utilized to record the cards being dealt. For example, as discussed below in relation to FIG. 9, a camera may be utilized to feed images of a live dealer dealing physical cards to one or more locations where the wagering game is conducted.

At least one of a card-handling device or a camera may be further utilized to determine value or rank of the cards provided to the community and dealer hands. These values may then be utilized in further administration of the wagering game (e.g., by enabling a virtual betting setting to credit players that have wagered on winning community hands).

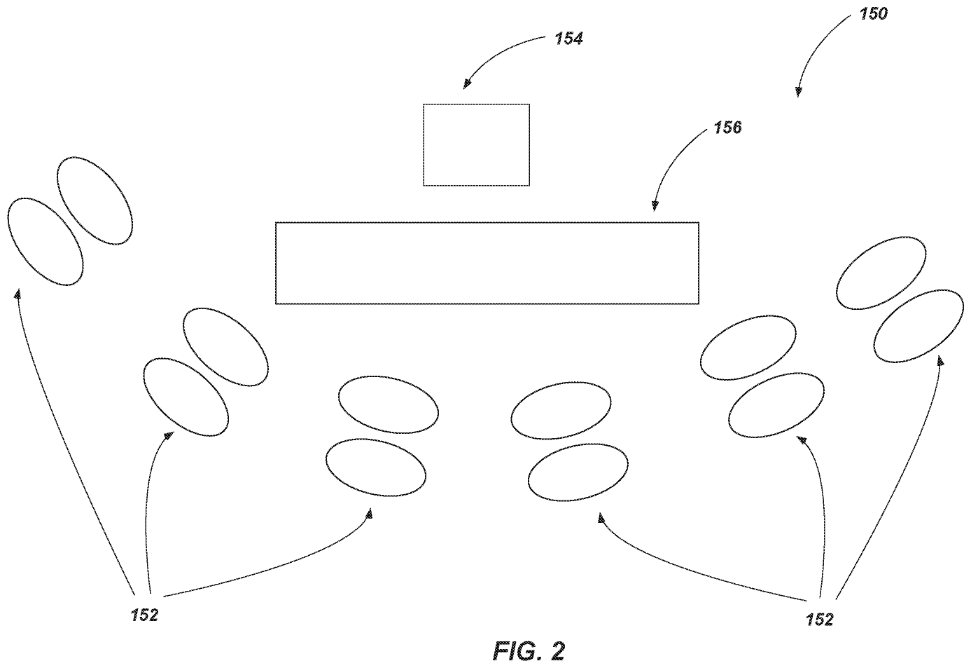

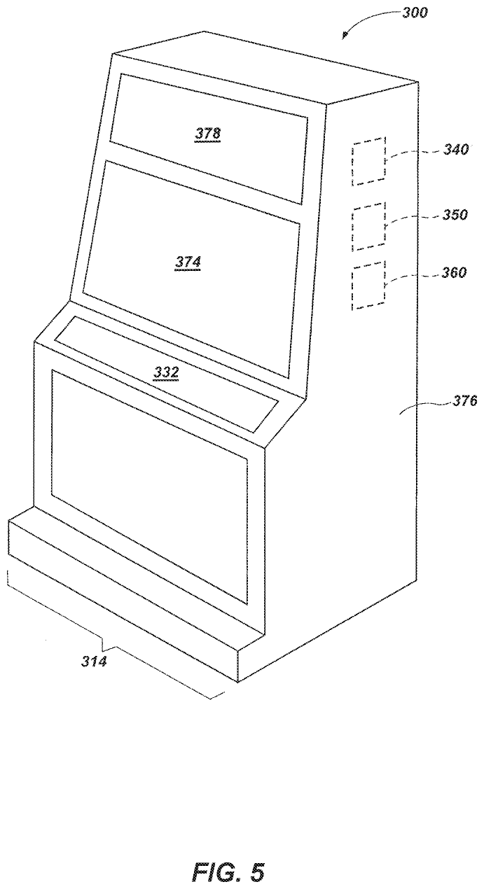

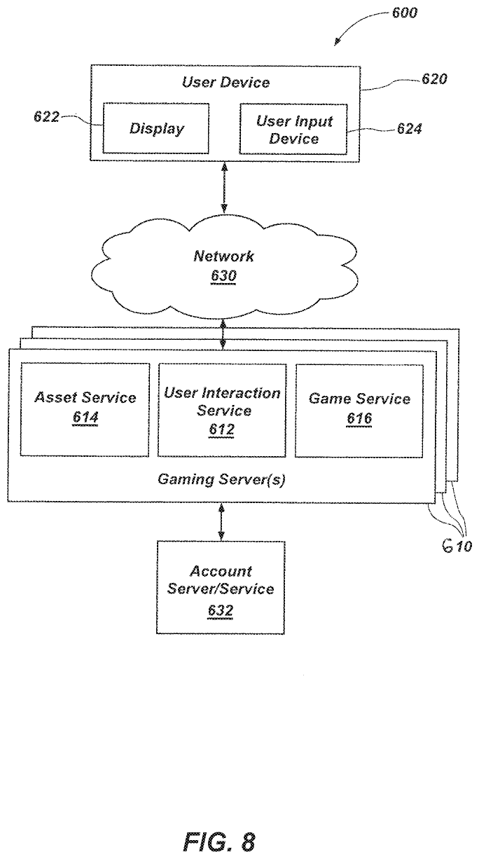

In some embodiments, the individual players may begin a gaming session at an electronic or physical gaming table 150, 400, or 500 (see FIGS. 2, 6, and 7) (e.g., by logging into a player account, by swiping a player account card, or by swiping a credit card) and interact with personal interface devices 332, 416a, 416b, 416c, 416d, 416e, 416f, 416g, 532a, 532b, 532c, 532d, 532e, 620 (see FIGS. 5 through 9) (e.g., touchscreens, keyboards, buttons, switches, etc.) to authorize placement of the one or more wagers. The wagers may be provided, for example, by placing physical money or physical representations of money (e.g., poker chips) in a designated area of a gaming table 150, 400, 500 (see FIGS. 2, 6, and 7), by displaying digital representations of money in a designated area of at least one display screen 374, 416a, 416b, 416c, 416d, 416e, 416f, 416g, 430, 532a, 532b, 532c, 532d, 532e, 560, 564, or 658 (see FIGS. 5 through 7 and 10), or by displaying a monetary amount of the wager on at least one display screen 374, 416a, 416b, 416c, 416d, 416e, 416f, 416g, 430, 532a, 532b, 532c, 532d, 532e, 560, 564, or 658 (see FIGS. 5 through 7 and 10), which may be remotely located from a dealer or game server 610 (see FIG. 8).

The one or more wagers may be accepted, for example, by electronically accepting funds from a player account or other credit authorized via one or more communications media (e.g., via the Internet, wireless communications, land line) on a remote electronic device (e.g., a personal computer, a laptop, a tablet computer, or a smartphone) by player input; electronically accepting funds from a player account authorized on a local wagering game administration device in a casino by player input; or physically placing money or representations of money (e.g., chips) on a table at a live game in a casino. Suitable network architecture for electronically accepting funds from a player account authorized on a remote device may comprise, for example, the network gaming architecture disclosed in U.S. patent application Ser. No. 13/353,194, filed Jan. 18, 2012, to Costello et al., and U.S. patent application Ser. No. 13/609,031, filed Sep. 10, 2012, to Costello et al., the disclosure of each of which is incorporated herein in its entirety by this reference. Suitable local wagering game administration devices may comprise, for example, the chipless tables disclosed in U.S. Patent Application Pub. No. 2010/0016050, published Jan. 21, 2010, to Snow et al., now U.S. Pat. No. 8,262,475, issued Sep. 11, 2012, the disclosure of which is incorporated herein in its entirety by this reference.

An ante wager may be accepted from at least one participating player on one or more of the community hands. The ante wager may be accepted before any cards are dealt, or at least before the at least one participating player is allowed to view any cards dealt to the one or more community hands.

By placing at least one ante wager, the dealer may deal the cards to the one or more community hands. By way of example and not limitation, one card may be dealt to each community hand and to at least one comparison hand (e.g., a dealer hand), although any predetermined number of cards may be dealt to each community hand as dictated by game or house rules (e.g., one, three, four, five, six, etc., cards). For example, physical cards that have been randomized (e.g., by manual or automated shuffling) may be distributed sequentially to each community hand, the order of which may be dictated by a set of game or house rules. In yet other embodiments, a community hand may be dealt in a packet of cards where additional cards are only used in the event of a tie with the dealer. In additional embodiments, digital representations of cards of the community hands (e.g., images resembling physical cards or characters and symbols) may be displayed on personal display screens 374, 416a, 416b, 416c, 416d, 416e, 416f, 416g, 532a, 532b, 532c, 532d, 532e, or 658 (see FIGS. 5 through 7 and 10) for individual players. In some embodiments, the electronically generated cards may be displayed, for example, to remote players over networks.

In some embodiments, such as the embodiment shown in FIG. 6, cards may be dealt from a shoe 422. The shoe may contain 6-8 intermixed decks of standard cards, each deck including 52 cards having a rank of 2 through Ace, with four suits including hearts, diamonds, spades and clubs. In some embodiments, one or more wild cards may be added to the shoe.

As discussed above, the high card of each community hand is compared to the high card of the dealer hand and additional cards are supplied, as necessary, in the case of tie between the community and dealer hand in a round. In some embodiments, where an interactive player display is implemented, the display may prompt the player for input (e.g., by pressing a button a representation of a button on a screen) on whether the player wants to proceed with the additional tie bet (e.g., “go to war”) or surrender the ante bet on the tied community hand.

After determining the hand having the higher card and resolving any tied hands, the wagers (e.g., the ante wager and/or the additional tie wager) may be resolved. Participating players that wagered on one or more of the community hands may receive a payout on the ante wager and the additional wager, if applicable, according to predetermined fixed odds for each wager (e.g., 1:1, 2:1, 3:1, etc.). For example, participating players that wagered on one or more of the community hands may receive a payout on the ante wager of 1:1 and a payout on the additional tie wager, if applicable, of 1:1. In some embodiments, if the community hand of the dealer hand ties twice, the player may receive a relatively larger payout (e.g., 3:1, 10:1, 11:1). In some embodiments, a separate tie wager may be placed by the player in order to receive the relatively larger payout accompanying the instance of two tie cards.

In other embodiments, payout of wagers may be determined based on a pay table.

In some embodiments, an advantage (e.g., a so-called “house edge”) may be provided to the casino or other establishment. For example, the advantage may be provided to the casino or other establishment by adjusting payout odds in favor of the casino or other establishment, by providing a rule that provides a house advantage, such as dictating that a game outcome that is normally a player win or tie is a dealer win, and/or by allowing the casino or other establishment to withhold a portion of every wager, such as by taking a rake (i.e., a certain percentage) of each ante wager or by the house retaining the ante wager(s) in the event of an initial tie between the high card of the community hand and the high card of the dealer hand.

Although the method 100 of administering a wagering game illustrated in FIG. 1 has been described as following a particular sequence, the present disclosure is not so limited. For example, all bets may be resolved at the end of the game after any tie hands have been addressed.

Various platforms are contemplated that are suitable for implementation of embodiments of wagering games according to this disclosure. For example, embodiments of wagering games may be implemented as live table games with an in-person dealer, electronic gaming machines, partially or fully automated table games, and partially or fully automated, network-administered games (e.g., Internet games) wherein game results may be produced utilizing a processor or a live video feed of a dealer administering a game from a remote studio. By way of further example, wagering games may be implemented on gaming tables, which may include physical gaming features, such as physical cards and physical chips, and may include a live dealer and a shuffler or shoe. More specifically, a live dealer may deal physical cards, evaluate hands, accept wagers, accept player elections, issue payouts, retain wagers, and perform other administrative functions of game play. Some embodiments may be implemented on electronic devices enabling electronic gaming features, such as providing electronic displays for display of virtual cards, virtual chips, game instructions, pay tables, etc. Some embodiments may include features that are a combination of physical and electronic features. For example, wagering games may be implemented on gaming devices with virtual betting systems while a live dealer (e.g., in person or via a video feed) may supply physical cards from a shuffler or shoe to the community and dealer hands.

As previously noted, any of the present methods and games may be played as a live casino table card game, as a hybrid casino table card game (with virtual cards or virtual chips), on a multi-player electronic platform (as disclosed in U.S. patent application Ser. No. 10/764,827, filed Jan. 26, 2004, published as U.S. Patent Application Publication No. 2005/0164759 on Jul. 28, 2005, now abandoned; U.S. patent application Ser. No. 10/764,994, filed Jan. 26, 2004, now U.S. Pat. No. 7,661,676, issued Feb. 16, 2010; and U.S. patent application Ser. No. 10/764,995, filed Jan. 26, 2004, now U.S. Pat. No. 8,272,958, issued Sep. 25, 2012; the disclosure of each of which applications and patents is incorporated herein in its entirety by this reference), on a personal computer for practice, on a hand-held game for practice, on a legally authorized site on the Internet, or on a play-for-fun site on the Internet.

For example, in one embodiment, the players may be remotely located from a live dealer, and a live dealer and a game table may be displayed to players on their monitors via a video feed. The players' video feeds may be transmitted to the dealer and may also be shared among the players at the table. In a sample embodiment, a central station may include a plurality of betting-type game devices and an electronic camera for each game device. A plurality of player stations, remotely located with respect to the central station, may each include a monitor, for displaying a selected game device at the central station, and input means, for selecting a game device and for placing a bet by a player at the player's station relating to an action involving an element of chance to occur at the selected game device. Further details on gambling systems and methods for remotely located players are disclosed in U.S. Pat. No. 6,755,741 B1, issued Jun. 29, 2004, titled “GAMBLING GAME SYSTEM AND METHOD FOR REMOTELY-LOCATED PLAYERS,” the disclosure of which is incorporated herein in its entirety by this reference.

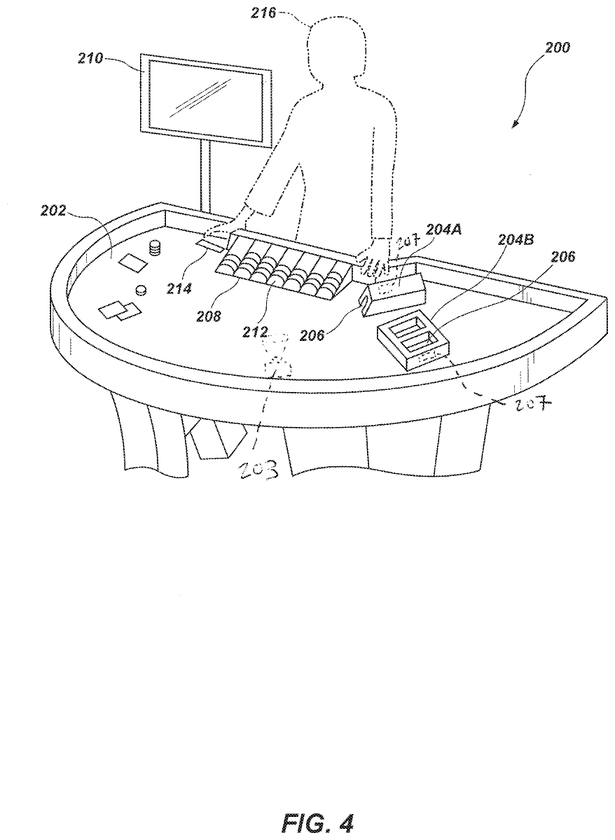

The wagering game may be administered by an electronic gaming machine, partially or fully automated table games, and partially or fully automated, network-administered games (e.g., Internet games) wherein game results may be produced utilizing a processor or a live video feed of a dealer administering a game from a remote studio. In such embodiments, electronic representations of the wagering game on at least one display screen 210, 374, 416a, 416b, 416c, 416d, 416e, 416f, 416g, 430, 532a, 523b, 532c, 532d, 532e, 560, 564, or 658 (see FIGS. 4 through 7 and 10) may include animations that relate to play of the wagering game. In some embodiments, the display screen may be a common display viewable by all participating players and in other embodiments, the display screens may be individualized and viewable by a single participating player associated with the display screen. The display screens may be configured to display animations responsive to outcomes of the wagering game for each participating player.

Although the wagering game has been described as involving a single player placing one or more wagers and competing against a dealer for the ante and additional tie wagers, the wagering game is not so limited. For example, the wagering game may be played with more than one participating player where select sets of one or more community hands are compared against each other.

FIG. 2, an exemplary diagram of a playing surface 150 (also referred to as “gaming table 150”) having one or more player positions 152 and a dealer card position 154 for implementation of the wagering game within the scope of the disclosure is shown. Such an implementation may include a felt layout on a physical gaming table or an electronic representation of a felt layout on a video display screen (see, e.g., FIGS. 5 through 7 and 10) for each participating player position 152. The playing surface 150 may include images related to the motif of the wagering game.

The playing surface 150 may define a plurality of the participating player positions 152 within which the activity (e.g., wagering) for individual players may take place. The dealer card position 154 may be a position where dealer cards may be dealt. For example, the dealer card position 154 may include an area where a number of cards of a dealer hand may be dealt and positioned, such as an area sufficiently large to position one initial card and any additional cards necessitated by a tie side-by-side or stacked in columns and rows.

As depicted, the playing surface 150 may include a community hand area 156 where each of the community hands is dealt. In some embodiments, indicia on the community hand area 156 may correspond to each of the community hands. Each player position 152 may include corresponding indicia are to indicate which community hand on which the player wishes to place a wager.

Although the playing surface 150 in FIG. 2 shows six player positions 152, the number of player positions 152 is not so limited. For example, the playing surface 152 may include any number of player positions 152, such as any number between two and ten, for example.

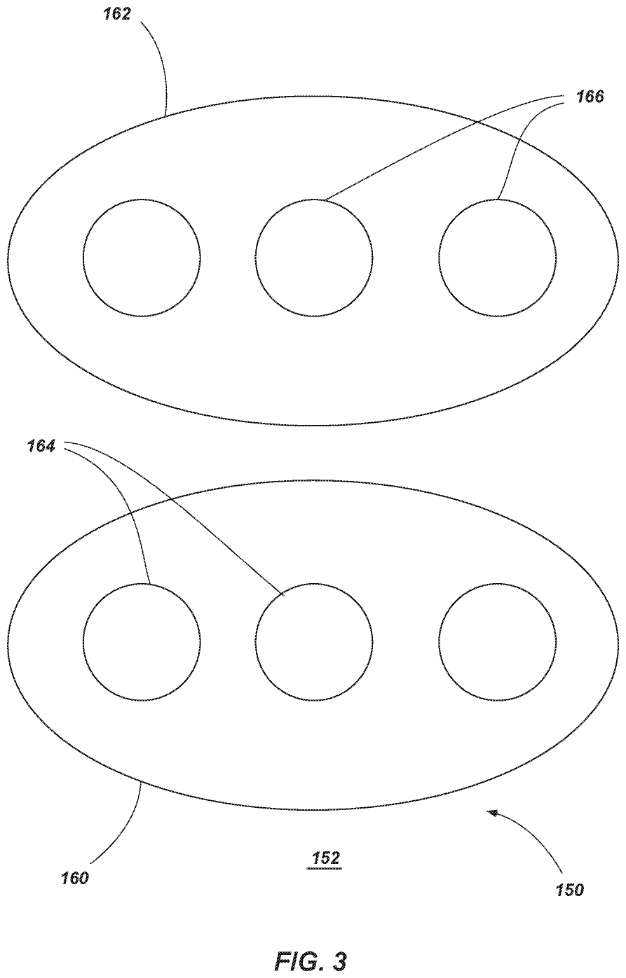

Referring to FIG. 3 an enlarged diagram of one of the player positions 152 of the playing surface 150 of FIG. 2 is shown. Each player position 152 may include at least one ante wager region 160 within which money or representations of money may be placed or displayed (e.g., physically positioned or digitally displayed) when the ante wager is accepted. As discussed above, the ante wager region 160 may include multiple areas or indicia 164 that correspond to the community hand that is being wagered on.

Each player position 152 may also include at least one additional tie wager region 162 within which one or more additional tie wagers may be placed when at least one community hand has tied with the dealer hand. As discussed above, and similar to the ante wager region 160, the additional tie wager region 162 may include multiple areas or indicia 166 that correspond to the community hand that is being wagered on. In this example, play on three community hands is offered, and there are three ante wager areas and three tie wager areas available to the player for wagering. In some embodiments, the at least one additional tie wager region 162 may include an area for placing the optional double tie wager.

In some embodiments, one or more of the wager regions may include sensors to automatically sense the presence and/or the value of a wager.

With combined reference to FIGS. 2 and 3, a specific embodiment of an implementation of the wagering game described in connection with FIG. 1 is presented. Play of a round of the wagering game may begin by accepting an ante wager on at least one of the community hands. The ante wager may be accepted from each participating player position 152 by receiving money or representations of money (e.g., chips) in the ante wager region 160. After the ante wagers have been accepted by placing the wagers in the respective positions, a number of cards (e.g., one, two, three, or more cards) may be dealt to the community hand area 156. In some embodiments, the cards may be delivered from a shuffler. The dealer may also deliver a corresponding number of cards (or less or more cards) to the dealer card position 154.

It is determined by a dealer or by the game processor whether the value (e.g., numerical value or rank) of the card of each community hand in the community hand area 156 is greater than, less than, or equal to the value of the card of the dealer hand in the dealer card position 154. If the value of the card of the community hand is less than the card of the dealer, the player loses the ante bet or, if the value of the card of the community hand is greater than that of the dealer, the player wins and the dealer pays the player an amount, such as, an amount equal to (e.g., 1:1) the ante bet of that player on that community hand. If the value of the card of the community hand and dealer hand are equal, additional cards may be dealt to each of the community hand and the dealer hand that are tied in the respective community hand area 156 and the dealer card position 154. The player may make an additional tie bet in the additional tie wager region 162 on the additional card or cards dealt to a community hand that has a high card equal to the high card of the dealer hand.

It is determined whether the value of the additional card of each community hand that has received an additional card is greater than, less than, or equal to the value of additional card of the dealer hand. If the value of the additional card of the community hand is less than the value of the additional card of the dealer, the player loses the additional tie bet on that community hand and the additional tie bet is collected from the area by the dealer. If the value of the additional card of the community hand is greater than that of the dealer, the player wins and the dealer pays the player an amount, such as, an amount equal to the additional bet of that player on that community hand. If the value of the additional card of the community hand and the additional dealer hand are equal again, yet additional cards may be dealt to each of the community hand and the dealer hand that are tied and the player may make another additional tie bet on the additional cards dealt to a community hand that has a high card equal to the high card of the dealer hand.

In an embodiment, the gaming system is network based and includes a central processor. A live dealer dispenses cards onto the surface of a gaming table, and the cards are imaged using an overhead camera imaging system. The overhead imaging system sends card information to the central processor. A card-dispensing device such as a card-reading shoe or shuffler is used to dispense the cards. Output from the card-reading device in the shoe is also sent to the central processor. The card values are displayed on a community display, and on each participating remote player terminal in communication with the gaming server. An administrative terminal is connected to the system via a network connection and enables an administrator to input administrative settings, such as the maximum number of community hands that can be played by each player simultaneously. This setting can be manually changed or automatically changed, based on time of day, or day of the week, or holidays, for example, when the casino expects changes in betting volume. In one embodiment, the administrator may select a maximum number of games that may be simultaneously played, such as three games, five games, one game, or any number of games between one and eight games.

When, for example the administrator allows three games to be played simultaneously, each player can bet on one, two or all three games simultaneously. In other embodiments, the player is required to play all eligible games simultaneously.

In some embodiments, the wagering games described herein may be played against a game administrator (i.e., against “the house” such that the game is “house-banked”). Such implementations may involve the game administrator (e.g., a casino or other gaming establishment) accepting (e.g., via a dealer or other agent of the administrator) wagers of real-world monetary value, distributing payouts of real-world monetary value on winning wagers to players, and collecting real-world monetary value of lost wagers. Such “house-banked” embodiments may be implemented, for example, in the form of a live table game, in a virtual table game, in an electronic game, or in a networked (e.g., Internet) game configuration.

In other embodiments, the wagering games, or at least one wager associated with the wagering games, may involve a player in a casino or other gaming establishment acting as banker, accepting wagers having real-world monetary value, issuing payouts having real-world monetary value, and collecting real-world monetary value of lost wagers (i.e., be “player-banked”). In some embodiments where at least one wager is player-banked, the game administrator may collect a player entrance fee, or a rake on each player-banked wager accepted from the participating players, including the banker.

FIG. 4 is a perspective view of an embodiment of a gaming table 200 for implementing wagering games in accordance with this disclosure. The gaming table 200 may be a physical article of furniture around which participants in the wagering game may stand or sit and on which the physical objects used for administering and otherwise participating in the wagering game may be supported, positioned, moved, transferred, and otherwise manipulated. For example, the gaming table 200 may include a gaming surface 202 on which the physical objects used in administering the wagering game may be located. The gaming surface 202 may be, for example, a felt fabric covering a hard surface of the table, and a design, conventionally referred to as a “layout,” specific to the game being administered may be physically printed on the gaming surface 202. As another example, the gaming surface 202 may be a surface of a transparent or translucent material (e.g., glass or plexiglass) onto which a projector 203, which may be located, for example, above or below the gaming surface 202, may illuminate a layout specific to the wagering game being administered. In such an example, the specific layout projected onto the gaming surface 202 may be changeable, enabling the gaming table 200 to be used to administer different variations of wagering games within the scope of this disclosure or other wagering games. Additional details of illustrative gaming surfaces and projectors are disclosed in U.S. patent application Ser. No. 13/919,849, filed Jun. 17, 2013, and titled “ELECTRONIC GAMING DISPLAYS, GAMING TABLES INCLUDING ELECTRONIC GAMING DISPLAYS AND RELATED ASSEMBLIES, SYSTEMS AND METHODS,” the disclosure of which is incorporated herein in its entirety by this reference. In either example, the gaming surface 202 may include, for example, designated areas for player positions; areas in which one or more of player cards, dealer cards, or community cards may be dealt; areas in which wagers may be accepted; areas in which wagers may be grouped into pots; and areas in which rules, pay tables, and other instructions related to the wagering game may be displayed. As a specific, non-limiting example, the gaming surface 202 may be configured as shown in FIGS. 2 and 3.

In some embodiments, the gaming table 200 may include a display 210 separate from the gaming surface 202. The display 210 may be configured to face players, prospective players, and spectators and may display, for example, rules, pay tables, real-time game status, such as wagers accepted and cards dealt, historical game information, such as amounts won, amounts wagered, percentage of hands won, and notable hands achieved, and other instructions and information related to the wagering game. The display 210 may be a physically fixed display, such as a poster, in some embodiments. In other embodiments, the display 210 may change automatically in response to a stimulus (e.g., may be an electronic video monitor).

The gaming table 200 may include particular machines and apparatuses configured to facilitate the administration of the wagering game. For example, the gaming table 200 may include one or more card-handling devices 204. The card-handling device 204A may be, for example, a shoe from which physical cards 206 from one or more decks of playing cards (e.g., six to eight decks) may be withdrawn, one at a time or more than one at a time. More specifically, the card-handling device 204 may be, for example, a mechanized, automatic shoe (i.e., a shoe including an internal, electromechanical, self-acting mechanism to handle card movement within the shoe, present cards for withdrawal, and optionally identify cards) or a non-mechanized shoe. Such a card-handling device 204A may include, for example, a housing in which cards 206 are located, an opening from which cards 206 are removed, and a card-presenting mechanism (e.g., a moving weight on a ramp configured to push a stack of cards down the ramp) configured to continually present new cards 206 for withdrawal from the shoe. Additional details of an illustrative card-handling device 204A configured as a shoe are found in U.S. Patent App. Pub. No. 2010/0038849, published Feb. 18, 2010, and titled “INTELLIGENT AUTOMATIC SHOE AND CARTRIDGE,” the disclosures of which is incorporated herein in its entirety by this reference.

The card-handling device 204B may be, for example, a shuffler configured to reorder physical cards 206 from one or more decks of playing cards and present randomized cards 206 for use in the wagering game. Such a card-handling device 204B may include, for example, a housing, a shuffling mechanism configured to shuffle cards, and card inputs and outputs (e.g., trays). More specifically, the card-handling device 204B may be, for example, a batch shuffler, a continuous shuffler, or a combination shuffler and shoe. Additional details of an illustrative card-handling device 204B configured as a shuffler are found in U.S. Pat. No. 8,070,574, issued Dec. 6, 2011, to Grauzer et al., the disclosure of which is incorporated herein in its entirety by this reference. Shufflers such as the devices disclosed in the '574 Patent may include card recognition capability and may form randomly ordered hands of a known composition within the shuffler. Additionally, game rules may also be programmed within the shuffler such that the processor of the shuffler is capable of identifying a winning wager prior to automatic delivery of cards for resolving the wager into a shoe or other card delivery. As a specific, non-limiting example, the card-handling device 204 may be a combination shuffler and shoe in which the output for the shuffler is a shoe.

In some embodiments, the card-handling device 204 may be configured and programmed to administer at least a portion of a wagering game being played utilizing the card-handling device 204. For example, the card-handling device 204 may be programmed and configured to randomize a set of cards and present one or more cards for use according to game rules. More specifically, the card-handling device 204 may be programmed and configured to, for example, randomize a set of cards including one or more 52-card decks of standard playing cards and, optionally, any specialty cards (e.g., a cut card, bonus cards, wild cards, or other specialty cards). In some embodiments, the card-handling device 204 may present individual cards, one at a time, for withdrawal from the card-handling device 204. In other embodiments, the card-handling device 204 may present packets of cards representing a subset of the complete set of cards handled by the card-handling device 204 (e.g., individual hands, one hand at a time, a group of hands, a partial hand or hands and then additional cards as needed to complete the hand or hands, a hand or hands and any burn or specialty cards to be used in the same round as the hand or hands) for withdrawal from the card-handling device 204. In some such embodiments, the card-handling device 204 may accept dealer input, such as, for example, a number of replacement cards for discarded cards, a number of hit cards to add, or a number of partial hands to be completed. In other such embodiments, the device may accept a dealer input from a menu of game options indicating a game selection, which will select programming to deliver the requisite number of cards to the game, depending on the game rules. The game rules may be programmed into the memory of the card-handling device 204. As specific, non-limiting examples, the card-handling device 204 may present a packet of cards representing a single hand or a packet of cards representing a group of hands, each hand including four cards, as described previously in connection with FIG. 1. In other embodiments, the card-handling device 204 may present cards one at a time for withdrawal, a dealer drawing, for example two, or four to deal to each player, as described previously in connection with FIG. 1.

Packets of cards used as community hands, partial community hands, dealer hands, partial dealer hands, community cards, or other card groups may be formed internally within the shuffler, such as within an internal compartment, as described in the '574 patent, or may be formed in an output tray of the shuffler. For example, U.S. Pat. No. 6,698,756, issued Mar. 2, 2004, to Baker et al. describes such a device. Other suitable shufflers include U.S. Pat. No. 6,267,248, issued Jul. 31, 2001, to Johnson et al., which describes a shuffler that can form a random set of cards, such as a deck or multiple decks, U.S. Pat. No. 7,766,332, issued Aug. 3, 2010, to Grauzer et al., which describes forming groups of player and/or dealer cards in compartments within a shuffler; U.S. Patent App. Pub. No. 2014/0027979, published Jan. 30, 2014, to Stasson et al., which shows an alternative method of randomly forming a set of cards in a shuffler such as one or more decks of cards; and U.S. Pat. No. 6,588,750, issued Jul. 8, 2003, to Grauzer et al., which shows a device for randomizing a set of cards using a gripping, lifting and insertion sequence. The disclosure of each of the foregoing documents is incorporated herein in its entirety by this reference.

In some embodiments, the card-handling device 204 may employ a random number generator device to determine card order, such as, for example, a final card order or an order of insertion of cards into a compartment configured to form a packet of cards. The compartments may be sequentially numbered, and a random number assigned to each compartment number prior to delivery of the first card. In other embodiments, the random number generator may select a location in the stack of cards to separate the stack into two sub-stacks, creating an insertion point within the stack at a random location. The next card may be inserted into the insertion point. In yet other embodiments, the random number generator may randomly select a location in a stack to randomly remove cards by activating an ejector.

Other functions of the random number generator may be game-specific. For example, a random number generator internal or external to the shuffler may be used to randomly select a player to receive a first packet of cards, including a hand or a portion of a hand, according to the game rules. In other examples, the random number generator may select a game position to receive an extra card, one less card, or a random number of cards, depending upon the specific rules of the game.

Regardless of whether the random number generator is hardware or software, it may be used to implement specific game administrations methods of the present disclosure. A suitable device employing random number generation for card management and randomization is marketed under the name MD3® by Bally Gaming, Inc. of Las Vegas, Nev. Aspects of this device are described in U.S. Pat. No. 8,579,289, issued Nov. 12, 2013, to Rynda et al., and the shuffling mechanism is fully described in U.S. Pat. No. 7,677,565, issued Mar. 16, 2010, to Grauzer et al., the disclosure of each of which is incorporated herein in its entirety by this reference.

The card-handling device 204 may simply be supported on the gaming surface 202 in some embodiments. In other embodiments, the card-handling device 204 may be mounted into the gaming table 202 such that the card-handling device 204 is not manually removable from the gaming table 202 without the use of tools. In some embodiments, the deck or decks of playing cards used may be standard, 52-card decks. In other embodiments, the deck or decks used may include cards, such as, for example, jokers, wild cards, bonus cards, etc. The shuffler may also be configured to handle and dispense security cards, such as cut cards.

In some embodiments, the card-handling device 204 may include an electronic display 207 for displaying information related to the wagering game being administered. For example, the electronic display 207 may display a menu of game options, the name of the game selected, the number of cards per hand to be dispensed, acceptable amounts for wagers (e.g., maximums and minimums), numbers of cards to be dealt to recipients, locations of particular recipients for particular cards, winning and losing wagers, pay tables, winning hands, losing hands, and payout amounts. In other embodiments, information related to the wagering game may be displayed on another electronic display, such as, for example, the display 210 described previously.

The type of card-handling device 204 employed to administer embodiments of the disclosed wagering game, as well as the type of card deck employed and the number of decks, may be specific the game to be implemented. Cards used in games of this disclosure may be, for example, standard playing cards from one or more decks, each deck having cards of four suits (clubs, hearts, diamonds, and spades) and of rankings ace, king, queen, jack, and ten through two in descending order. As a more specific example, six, seven, or eight standard decks of such cards may be intermixed. Typically, six or eight decks of 52 standard playing cards each may be intermixed and formed into a set. A suitable device employing random number generation for card management and randomization is marketed under the name MD3® by Bally Gaming, Inc. of Las Vegas, Nev. Aspects of this device are described in U.S. Pat. No. 8,579,289, issued Nov. 12, 2013, to Rynda et al., and the shuffling mechanism is fully described in U.S. Pat. No. 7,677,565, issued Mar. 16, 2010, to Grauzer et al., the disclosure of each of which is incorporated herein in its entirety by this reference. After shuffling, the randomized set may be transferred into another portion of the card-handling device 204B or another card-handling device 204A altogether, such as a mechanized shoe capable of reading card rank and suit. More specifically, the shoe disclosed in, for example, U.S. Pat. No. 8,511,684, issued Aug. 20, 2013, to Grauzer et al., the disclosure of which is incorporated herein in its entirety by this reference, may be used to automatically dispense one or more cards at a time from the randomized set.

In some embodiments, randomization of the cards may occur off-site, such as, for example, by purchasing the set of cards in its randomized form and introducing the randomized set of cards into the card-handling device 204 for delivery. In other embodiments, the cards may be randomized on-site before, during, or both before and during administration of the wagering game. For example, the set of cards may be randomized in a batch shuffler and introduced into a shoe for dealing or the set of cards may be continuously shuffled by a continuous shuffler, introduced in sets into a shoe integral to the continuous shuffler, withdrawn from the shoe and used for game play, and finally reintroduced into the continuous shuffler. After randomization, the set of cards may be transferred into another portion of the card-handling device 204 or another card-handling device 204 altogether, such as a mechanized shoe capable of reading card rank and suit.

In some embodiments, the wagering game may be hand-pitched. For example, a live, in-person dealer may deal cards from a set not located in a card-handling device. In some such embodiments, the dealer may also randomize the cards by hand-shuffling the set of cards.

The gaming table 200 may include one or more chip racks 208 configured to facilitate accepting wagers, transferring lost wagers to the house, and exchanging monetary value for wagering elements 212 (e.g., chips). For example, the chip rack 208 may include a series of token support rows, each of which may support tokens of a different type (e.g., color and denomination). In some embodiments, the chip rack 208 may be configured to automatically present a selected number of chips using a chip-cutting-and-delivery mechanism. Additional details of an illustrative chip rack 208 and chip-cutting-and-delivery mechanism are found in U.S. Pat. No. 7,934,980, issued May 3, 2011, to Blaha et al., the disclosure of which is incorporated herein in its entirety by this reference. In some embodiments, the gaming table 200 may include a drop box 214 for money that is accepted in exchange for wagering elements 212. The drop box 214 may be, for example, a secure container (e.g., a safe or lockbox) having a one-way opening into which money may be inserted and a secure, lockable opening from which money may be retrieved. Such drop boxes 214 are known in the art, and may be incorporated directly into the gaming table 200 and may, in some embodiments, have a removable container for the retrieval of money in a separate, secure location.

When administering a wagering game in accordance with embodiments of this disclosure, a dealer 216 may receive money (e.g., cash) from a player in exchange for wagering elements 212. The dealer 216 may deposit the money in the drop box 214 and transfer physical wagering elements 212 to the player. The dealer 216 may accept one or more initial wagers antes and other wagers) from the player, which may be reflected by the dealer 216 permitting the player to place one or more wagering elements 212 or other wagering tokens (e.g., cash) within designated areas on the gaming surface 202 associated with the various wagers of the wagering game. Once initial wagers have been accepted, the dealer 216 may remove physical cards 206 from the card-handling device 204 (e.g., individual cards, packets of cards, or the complete set of cards) in some embodiments. In other embodiments, the physical cards 206 may be hand-pitched (i.e., the dealer 216 may optionally shuffle the cards 206 to randomize the set and may hand-deal cards 206 from the randomized set of cards). The dealer 216 may position cards 206 within designated areas on the gaming surface 202, which may designate the cards 206 for use as individual player cards, community cards, or dealer cards in accordance with game rules. House rules also may allow the player to place wagers during card distribution, or after card distribution, but before revealing the cards.

After dealing the cards 206, and during play, according to the game rules, any additional wagers (e.g., play bets) may be accepted, which may be reflected by the dealer 216 permitting the player to place one or more wagering elements 212 within designated areas on the gaming surface 202 associated with the various wagers of the wagering game. In some embodiments, a player may fold, which may result in the dealer 216 collecting at least one of the wagering elements 212 from that player and transferring it to the house, which may be reflected by the wagering element 212 being returned to the chip rack 208. The dealer 216 may perform any additional card dealing and rounds of betting permitted in the wagering game. Finally, the dealer 216 may resolve the wagers, award winning wagers to the players, which may be accomplished by giving wagering elements 212 from the chip rack 208 to the players, and transferring losing wagers to the house, which may be accomplished by moving wagering elements 212 from the players to the chip rack 208.

FIG. 5 is a perspective view of an individual electronic gaming device 300 (e.g., an electronic gaming machine (EGM)) configured for implementing wagering games according to this disclosure. The individual electronic gaming device 300 may include an individual player position 314 including a player input area 332 configured to enable a player to interact with the individual electronic gaming device 300 through various input devices (e.g., buttons, levers, touchscreens). The individual electronic gaming device 300 may include a gaming screen 374 configured to display indicia for interacting with the individual electronic gaming device 300, such as through processing one or more programs stored in memory 340 to implement the rules of game play at the individual electronic gaming device 300. Accordingly, game play may be accommodated without involving physical playing cards, chips or other wagering elements, and live personnel. The action may instead be simulated by a control processor 350 operably coupled to the memory 340 and interacting with and controlling the individual electronic gaming device 300.

Although the individual electronic gaming device 300 displayed in FIG. 5 has an outline of a traditional gaming cabinet, the individual electronic gaming device 300 may be implemented in other ways, such as, for example, client software downloaded to a portable device, such as a smartphone, tablet, or laptop computer. The individual electronic gaming device 300 may also be a non-portable personal computer (e.g., a desktop or all-in-one computer) or other computing device. In some embodiments, client software is not downloaded but is native to the device or is otherwise delivered with the device when distributed.

A communication device 360 may be included and operably coupled to the processor 350 such that information related to operation of the individual electronic gaming device 300, information related to the game play, or combinations thereof may be communicated between the individual electronic gaming device 300 and other devices, such as a server, through a suitable communication medium, such, as, for example, wired networks, Wi-Fi networks, and cellular communication networks.

The gaming screen 374 may be carried by a generally vertically extending cabinet 376 of the individual electronic gaming device 300. The individual electronic gaming device 300 may further include banners to communicate rules of game play and the like, such as along a top portion 378 of the cabinet 376 of the individual electronic gaming device 300. The individual electronic gaming device 300 may further include additional decorative lights (not shown), and speakers (not shown) for transmitting and optionally receiving sounds during game play. Further detail of an example of an individual electronic gaming device 300 (as well as other embodiments of tables and devices) is disclosed in U.S. patent application Ser. No. 13/963,165, filed Aug. 9, 2013, and titled “METHODS AND SYSTEMS FOR ELECTRONIC GAMING,” the disclosure of which is incorporated herein in its entirety by this reference.

Some embodiments may be implemented at locations including a plurality of player stations. Such player stations may include an electronic display screen for display of game information (e.g., cards, wagers, and game instructions) and for accepting wagers and facilitating credit balance adjustments. Such player stations may, optionally, be integrated in a table format, may be distributed throughout a casino or other gaming site, or may include both grouped and distributed player stations.

FIG. 6 is a top view of a suitable table 400 configured for implementing wagering games according to this disclosure. The table 400 may include a playing surface 404. The table 400 may include player stations 412. Each player station 412 may include a player interface 416, which may be used for displaying game information (e.g., game instructions, input options, wager information, game outcomes, etc.) and accepting player elections. The player interface 416 may be a display screen in the form of a touchscreen, which may be at least substantially flush with the playing surface 404 in some embodiments. Each player interface 416 may be operated by its own local game processor 414 (shown in dashed lines), although, in some embodiments, a central game processor 428 (shown in dashed lines) may be employed and may communicate directly with player interfaces 416. In some embodiments, a combination of individual local game processors 414 and the central game processor 428 may be employed. Each of the processors 414 and 428 may be operably coupled to memory including one or more programs related to the rules of game play at the table 400.

A communication device 460 may be included and may be operably coupled to one or more of the local game processors 414, the central game processor 428, or combinations thereof, such that information related to operation of the table 400, information related to the game play, or combinations thereof may be communicated between the table 400 and other devices through a suitable communication medium, such as, for example, wired networks, Wi-Fi networks, and cellular communication networks.

The table 400 may further include additional features, such as a dealer chip tray 420, which may be used by the dealer to cash players in and out of the wagering game, whereas wagers and balance adjustments during game play may be performed using, for example, virtual chips (e.g., images or text representing wagers). For embodiments using physical cards 406a and 406b, the table 400 may further include a card-handling device 422, which may be configured to shuffle, read, and deliver physical cards for the dealer and players to use during game play or, alternatively, a card shoe configured to read and deliver cards that have already been randomized. For embodiments using virtual cards, the virtual cards may be displayed at the individual player interfaces 416. Common virtual cards may be displayed in a common card area.

The table 400 may further include a dealer interface 418, which, like the player interfaces 416, may include touchscreen controls for receiving dealer inputs and assisting the dealer in administering the wagering game. The table 400 may further include an upright display 430 configured to display images that depict game information such as pay tables, hand counts, historical win/loss information by player, and a wide variety of other information considered useful to the players. The upright display 430 may be double sided to provide such information to players as well as to casino personnel.

Further detail of an example of a table and player displays is disclosed in U.S. Pat. No. 8,262,475, issued Sep. 11, 2012, and titled “CHIPLESS TABLE SPLIT SCREEN FEATURE,” the disclosure of which is incorporated herein in its entirety by this reference. Although an embodiment is described showing individual discrete player stations, in some embodiments, the entire playing surface 404 may be an electronic display that is logically partitioned to permit game play from a plurality of players for receiving inputs from, and displaying game information to, the players, the dealer, or both.

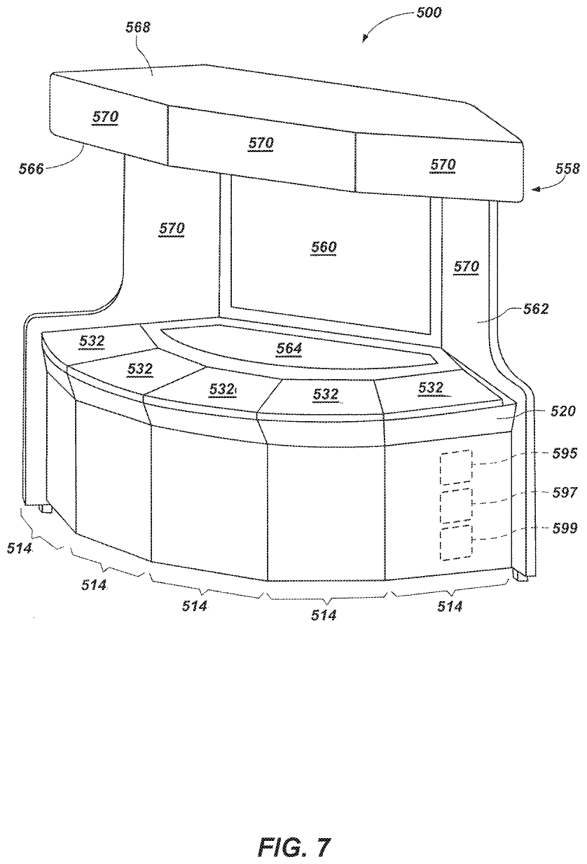

FIG. 7 is a perspective view of another embodiment of a suitable table 500 configured for implementing wagering games according to the present disclosure utilizing a virtual dealer. The table 500 may include player positions 514 arranged in a bank about an arcuate edge 520 of a video device 558 that may comprise a card screen 564 and a dealer screen 560. The dealer screen 560 may display a video simulation of the dealer (i.e., a virtual dealer) for interacting with the video device 558, such as through processing one or more stored programs stored in memory 595 to implement the rules of game play at the video device 558. The dealer screen 560 may be carried by a generally vertically extending cabinet 562 of the video device 558. The card screen 564 may be configured to display at least one or more of the dealer's cards, any community cards, and player's cards by the virtual dealer on the dealer screen 560.

Each of the player positions 514 may include a player interface area 532 configured for wagering and game play interactions with the video device 558 and virtual dealer. Accordingly, game play may be accommodated without involving physical playing cards, poker chips, and live personnel. The action may instead be simulated by a control processor 597 interacting with and controlling the video device 558. The control processor 597 may be programmed, by known techniques, to implement the rules of game play at the video device 558. As such, the control processor 597 may interact and communicate with display/input interfaces and data entry inputs for each player interface area 532 of the video device 558. Other embodiments of tables and gaming devices may include a control processor that may be similarly adapted to the specific configuration of its associated device.

A communication device 599 may be included and operably coupled to the control processor 597 such that information related to operation of the table 500, information related to the game play, or combinations thereof may be communicated between the table 500 and other devices, such as a central server, through a suitable communication medium, such, as, for example, wired networks, Wi-Fi networks, and cellular communication networks.

The video device 558 may further include banners communicating rules of play and the like, which may be located along one or more walls 570 of the cabinet 562. The video device 558 may further include additional decorative lights and speakers, which may be located on an underside surface 566, for example, of a generally horizontally extending top 568 of the cabinet 562 of the video device 558 generally extending toward the player positions 514.

Further detail of an example of a table and player displays is disclosed in U.S. Pat. No. 8,272,958, issued Sep. 25, 2012, and titled “AUTOMATED MULTIPLAYER GAME TABLE WITH UNIQUE IMAGE FEED OF DEALER,” the disclosure of which is incorporated herein in its entirety by this reference. Although an embodiment is described showing individual discrete player stations, in some embodiments, the entire playing surface (e.g., player interface areas 532, card screen 564, etc.) may be a unitary electronic display that is logically partitioned to permit game play from a plurality of players for receiving inputs from, and displaying game information to, the players, the dealer, or both.

In some embodiments, wagering games in accordance with this disclosure may be administered using a gaming system employing a client-server architecture (e.g., over the Internet, a local area network, etc.). FIG. 8 is a schematic block diagram of an illustrative gaming system 600 for implementing wagering games according to this disclosure. The gaming system 600 may enable end users to remotely access game content. Such game content may include, without limitation, various types of wagering games such as card games, dice games, big wheel games, roulette, scratch off games (“scratchers”), and any other wagering game where the game outcome is determined, in whole or in part, by one or more random events. This includes, but is not limited to, Class II and Class III games as defined under 25 U.S.C. § 2701 et seq. (“Indian Gaming Regulatory Act”). Such games may include banked and/or non-banked games.

The wagering games supported by the gaming system 600 may be operated with real currency or with virtual credits or other virtual (e.g., electronic) value indicia. For example, the real currency option may be used with traditional casino and lottery-type wagering games in which money or other items of value are wagered and may be cashed out at the end of a game session. The virtual credits option may be used with wagering games in which credits (or other symbols) may be issued to a player to be used for the wagers. A player may be credited with credits in any way allowed, including, but not limited to, a player purchasing credits; being awarded credits as part of a contest or a win event in this or another game (including non-wagering games); being awarded credits as a reward for use of a product, casino, or other enterprise, time played in one session, or games played; or may be as simple as being awarded virtual credits upon logging in at a particular time or with a particular frequency, etc. Although credits may be won or lost, the ability of the player to cash out credits may be controlled or prevented. In one example, credits acquired (e.g., purchased or awarded) for use in a play-for-fun game may be limited to non-monetary redemption items, awards, or credits usable in the future or for another game or gaming session. The same credit redemption restrictions may be applied to some or all of credits won in a wagering game as well.

An additional variation includes web-based sites having both play-for-fun and wagering games, including issuance of free (non-monetary) credits usable to play the play-for-fun games. This feature may attract players to the site and to the games before they engage in wagering. In some embodiments, a limited number of free or promotional credits may be issued to entice players to play the games. Another method of issuing credits includes issuing free credits in exchange for identifying friends who may want to play. In another embodiment, additional credits may be issued after a period of time has elapsed to encourage the player to resume playing the game. The gaming system 600 may enable players to buy additional game credits to allow the player to resume play. Objects of value may be awarded to play-for-fun players, which may or may not be in a direct exchange for credits. For example, a prize may be awarded or won for a highest scoring play-for-fun player during a defined time interval. All variations of credit redemption are contemplated, as desired by game designers and game hosts (the person or entity controlling the hosting systems).

The gaming system 600 may include a gaming platform to establish a portal for an end user to access a wagering game hosted by one or more gaming servers 610 over a network 630. In some embodiments, games are accessed through a user interaction service 612. The gaming system 600 enables players to interact with a user device 620 through a user input device 624 and a display 622 and to communicate with one or more gaming servers 610 using a network 630 (e.g., the Internet). Typically, the user device is remote from the gaming server 610 and the network is the word-wide web (i.e., the Internet).

In some embodiments, the gaming servers 610 may be configured as a single server to administer wagering games in combination with the user device 620. In other embodiments, the gaming servers 610 may be configured as separate servers for performing separate, dedicated functions associated with administering wagering games. Accordingly, the following description also discusses “services” with the understanding that the various services may be performed by different servers or combinations of servers in different embodiments. As shown in FIG. 8, the gaming servers 610 may include a user interaction service 612, a game service 616, and an asset service 614. In some embodiments, one or more of the gaming servers 610 may communicate with an account server 632 performing an account service 632. As explained more fully below, for some wagering type games, the account service 632 may be separate and operated by a different entity than the gaming servers 610; however, in some embodiments the account service 632 may also be operated by one or more of the gaming servers 610.

The user device 620 may communicate with the user interaction service 612 through the network 630. The user interaction service 612 may communicate with the game service 616 and provide game information to the user device 620. In some embodiments, the game service 616 may also include a game engine. The game engine may, for example, access, interpret, and apply game rules. In some embodiments, a single user device 620 communicates with a game provided by the game service 616, while other embodiments may include a plurality of user devices 620 configured to communicate and provide end users with access to the same game provided by the game service 616. In addition, a plurality of end users may be permitted to access a single user interaction service 612, or a plurality of user interaction services 612, to access the game service 616. The user interaction service 612 may enable a user to create and access a user account and interact with game service 616. The user interaction service 612 may enable users to initiate new games, join existing games, and interface with games being played by the user.

The user interaction service 612 may also provide a client for execution on the user device 620 for accessing the gaming servers 610. The client provided by the gaming servers 610 for execution on the user device 620 may be any of a variety of implementations depending on the user device 620 and method of communication with the gaming servers 610. In one embodiment, the user device 620 may connect to the gaming servers 610 using a web browser, and the client may execute within a browser window or frame of the web browser. In another embodiment, the client may be a stand-alone executable on the user device 620.

For example, the client may comprise a relatively small amount of script (e.g., JAVASCRIPT®), also referred to as a “script driver,” including scripting language that controls an interface of the client. The script driver may include simple function calls requesting information from the gaming servers 610. In other words, the script driver stored in the client may merely include calls to functions that are externally defined by, and executed by, the gaming servers 610. As a result, the client may be characterized as a “thin client.” The client may simply send requests to the gaming servers 610 rather than performing logic itself. The client may receive player inputs, and the player inputs may be passed to the gaming servers 610 for processing and executing the wagering game. In some embodiments, this may involve providing specific graphical display information for the display 622 as well as game outcomes.

As another example, the client may comprise an executable file rather than a script. The client may do more local processing than does a script driver, such as calculating where to show what game symbols upon receiving a game outcome from the game service 616 through user interaction service 612. In some embodiments, portions of an asset service 614 may be loaded onto the client and may be used by the client in processing and updating graphical displays. Some form of data protection, such as end-to-end encryption, may be used when data is transported over the network 630. The network 630 may be any network, such as, for example, the Internet or a local area network.

The gaming servers 610 may include an asset service 614, which may host various media assets (e.g., text, audio, video, and image files) to send to the user device 620 for presenting the various wagering games to the end user. In other words, the assets presented to the end user may be stored separately from the user device 620. For example, the user device 620 requests the assets appropriate for the game played by the user; as another example, especially relating to thin clients, just those assets that are needed for a particular display event will be sent by the gaming servers 610, including as few as one asset. The user device 620 may call a function defined at the user interaction service 612 or asset service 614, which may determine which assets are to be delivered to the user device 620 as well as how the assets are to be presented by the user device 620 to the end user. Different assets may correspond to the various user devices 620 and their clients that may have access to the game service 616 and to different variations of wagering games.

The gaming servers 610 may include the game service 616, which may be programmed to administer wagering games and determine game play outcomes to provide to the user interaction service 612 for transmission to the user device 620. For example, the game service 616 may include game rules for one or more wagering games, such that the game service 616 controls some or all of the game flow for a selected wagering game as well as the determined game outcomes. The game service 616 may include pay tables and other game logic. The game service 616 may perform random number generation for determining random game elements of the wagering game. In one embodiment, the game service 616 may be separated from the user interaction service 612 by a firewall or other method of preventing unauthorized access to the game service 612 by the general members of the network 630.

The user device 620 may present a gaming interface to the player and communicate the user interaction from the user input device 624 to the gaming servers 610. The user device 620 may be any electronic system capable of displaying gaming information, receiving user input, and communicating the user input to the gaming servers 610. For example, the user device 620 may be a desktop computer, a laptop, a tablet computer, a set-top box, a mobile device (e.g., a smartphone), a kiosk, a terminal, or another computing device. As a specific, non-limiting example, the user device 620 operating the client may be an interactive electronic gaming system 300 (see FIG. 5), as described above. The client may be a specialized application or may be executed within a generalized application capable of interpreting instructions from an interactive gaming system, such as a web browser.

The client may interface with an end user through a web page or an application that runs on a device including, but not limited to, a smartphone, a tablet, or a general computer, or the client may be any other computer program configurable to access the gaming servers 610. The client may be illustrated within a casino webpage (or other interface) indicating that the client is embedded into a webpage, which is supported by a web browser executing on the user device 620.

In some embodiments, components of the gaming system 600 may be operated by different entities. For example, the user device 620 may be operated by a third party, such as a casino or an individual, that links to the gaming servers 610, which may be operated, for example, by a wagering game service provider. Therefore, in some embodiments, the user device 620 and client may be operated by a different administrator than the operator of the game service 616. In other words, the user device 620 may be part of a third-party system that does not administer or otherwise control the gaming servers 610 or game service 616. In other embodiments, the user interaction service 612 and asset service 614 may be operated by a third-party system. For example, a gaming entity (e.g., a casino) may operate the user interaction service 612, user device 620, or combination thereof to provide its customers access to game content managed by a different entity that may control the game service 616, amongst other functionality. In still other embodiments, all functions may be operated by the same administrator. For example, a gaming entity (e.g., a casino) may elect to perform each of these functions in-house, such as providing access to the user device 620, delivering the actual game content, and administering the gaming system 600.

The gaming servers 610 may communicate with one or more external account servers 632 (also referred to herein as an account service 632), optionally through another firewall. For example, the gaming servers 610 may not directly accept wagers or issue payouts. That is, the gaming servers 610 may facilitate online casino gaming but may not be part of a self-contained online casino itself. Another entity (e.g., a casino or any account holder or financial system of record) may operate and maintain its external account service 632 to accept bets and make payout distributions. The gaming servers 610 may communicate with the account service 632 to verify the existence of funds for wagering and to instruct the account service 632 to execute debits and credits. As another example, the gaming servers 610 may directly accept bets and make payout distributions, such as in the case where an administrator of the gaming servers 610 operates as a casino.

Additional features may be supported by the gaming servers 610, such as hacking and cheating detection, data storage and archival, metrics generation, messages generation, output formatting for different end user devices, as well as other features and operations. For example, the gaming servers 610 may include additional features and configurations as described in U.S. patent application Ser. No. 13/353,194, filed Jan. 18, 2012, and U.S. patent application Ser. No. 13/609,031, filed Sep. 10, 2012, both applications titled “NETWORK GAMING ARCHITECTURE, GAMING SYSTEMS, AND RELATED METHODS,” the disclosure of each of which is incorporated herein in its entirety by this reference.

FIG. 9 is a schematic block diagram of a table 682 for implementing wagering games including a live dealer feed. Features of the gaming system 600 (see FIG. 8) described above in connection with FIG. 9 may be utilized in connection with this embodiment, except as further described. Rather than cards being determined by computerized random processes, physical cards (e.g., from a standard, 52-card deck of playing cards) may be dealt by a live dealer 680 at a table 682 from a card-handling system 684. A table manager 686 may assist the dealer 680 in facilitating play of the game by transmitting a video feed of the dealer's actions to the user device 620 and transmitting player elections to the dealer 680. As described above, the table manager 686 may act as or communicate with a gaming system 600 (see FIG. 8) (e.g., acting as the gaming system 600 (see FIG. 8) itself or as an intermediate client interposed between and operationally connected to the user device 620 and the gaming system 600 (see FIG. 8)) to provide gaming at the table 682 to users of the gaming system 600 (see FIG. 8). Thus, the table manager 686 may communicate with the user device 620 through a network 630 (see FIG. 8), and may be a part of a larger online casino, or may be operated as a separate system facilitating game play. In various embodiments, each table 682 may be managed by an individual table manager 686 constituting a gaming device, which may receive and process information relating to that table. For simplicity of description, these functions are described as being performed by the table manager 686, though certain functions may be performed by an intermediary gaming system 600 (see FIG. 8), such as the one shown and described in connection with FIG. 8. In some embodiments, the gaming system 600 (see FIG. 8) may match remotely located players to tables 682 and facilitate transfer of information between user devices 620 and tables 682, such as wagering amounts and player option elections, without managing gameplay at individual tables. In other embodiments, functions of the table manager 686 may be incorporated into a gaming system 600 (see FIG. 8).

The table 682 includes a camera 670 and optionally a microphone 672 to capture video and audio feeds relating to the table 682. The camera 670 may be trained on the dealer 680, play area 687, and card-handling system 684. As the game is administered by the dealer 680, the video feed captured by the camera 670 may be shown to the player using the user device 620, and any audio captured by the microphone 672 may be played to the player using the user device 620. In some embodiments, the user device 620 may also include a camera, microphone, or both, which may also capture feeds to be shared with the dealer 680 and other players. In some embodiments, the camera 670 may be trained to capture images of the card faces, chips, and chip stacks on the surface of the gaming table. Known image extraction techniques may be used to obtain card count and card rank and suit information from the card images. An example of suitable image extraction software is disclosed in U.S. Pat. No. 7,901,285, issued Mar. 8, 2011, to Tran et al., the disclosure of which is incorporated in this disclosure in its entirety by this reference.

Card and wager data in some embodiments may be used by the table manager 686 to determine game outcome. The data extracted from the camera 670 may be used to confirm the card data obtained from the card-handling system 684, to determine a player position that received a card, and for general security monitoring purposes, such as detecting player or dealer card switching, for example. Examples of card data include, for example, suit and rank information of a card, suit and rank information of each card in a hand, rank information of a hand, and rank information of every hand in a round of play.

The live video feed permits the dealer to show cards dealt by the card-handling system 684 and play the game as though the player were at a live casino. In addition, the dealer can prompt a user by announcing a player's election is to be performed. In embodiments where a microphone 672 is included, the dealer 680 can verbally announce action or request an election by a player. In some embodiments, the user device 620 also includes a camera or microphone, which also captures feeds to be shared with the dealer 680 and other players.

The card-handling system 684 may be as shown and described previously in connection with FIG. 4. The play area 687 depicts player positions for playing the game, such as shown in FIGS. 2 and 3. As determined by the rules of the game, the player at the user device 620 may be presented options for responding to an event in the game using a client as described with reference to FIG. 8.

Player elections may be transmitted to the table manager 686, which may display player elections to the dealer 680 using a dealer display 688 and player action indicator 690 on the table 682. For example, the dealer display 688 may display information regarding where to deal the next card or which player position is responsible for the next action.

In some embodiments, the table manager 686 may receive card information from the card-handling system 684 to identify cards dealt by the card-handling system 684. For example, the card-handling system 684 may include a card reader to determine card information from the cards. The card information may include the rank and suit of each dealt card and hand information.

The table manager 686 may apply game rules to the card information, along with the accepted player decisions, to determine gameplay events and wager results. Alternatively, the wager results may be determined by the dealer 680 and input to the table manager 686, which may be used to confirm automatically determined results by the gaming system.

Card and wager data in some embodiments may be used by the table manager 686 to determine game outcome. The data extracted from the camera 670 may be used to confirm the card data obtained from the card-handling system 684, to determine a player position that received a card, and for general security monitoring purposes, such as detecting player or dealer card switching, for example.

The live video feed permits the dealer to show cards dealt by the card-handling system 684 and play the game as though the player were at a live casino. In addition, the dealer can prompt a user by announcing a player's election is to be performed. In embodiments where a microphone 672 is included, the dealer 680 can verbally announce action or request an election by a player. In some embodiments, the user device 620 also includes a camera or microphone, which also captures feeds to be shared with the dealer 680 and other players.

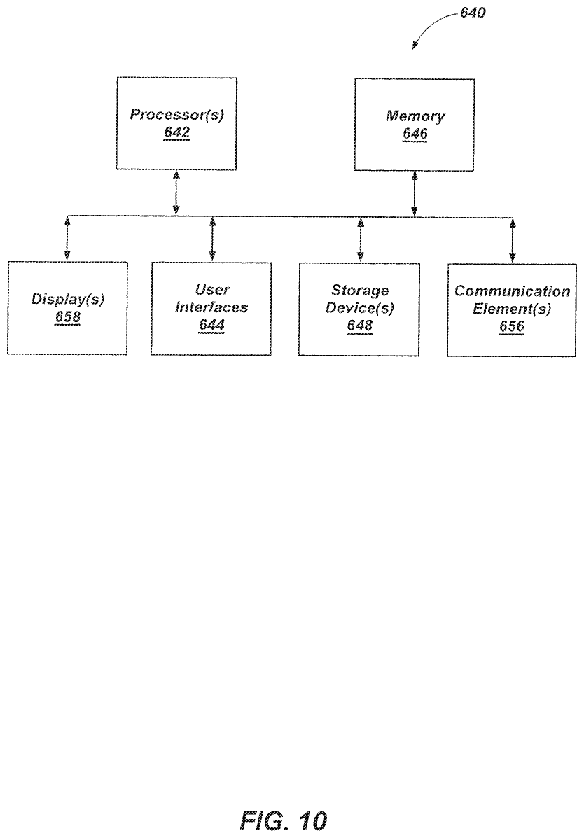

FIG. 10 is a simplified block diagram showing elements of computing devices that may be used in systems and apparatuses of this disclosure. A computing system 640 may be a user-type computer, a file server, a computer server, a notebook computer, a tablet, a handheld device, a mobile device, or other similar computer system for executing software. The computing system 640 may be configured to execute software programs containing computing instructions and may include one or more processors 642, memory 646, one or more displays 658, one or more user interface elements 644, one or more communication elements 656, and one or more storage devices 648 (also referred to herein simply as storage 648).

The processors 642 may be configured to execute a wide variety of operating systems and applications including the computing instructions for administering wagering games of the present disclosure.

The processors 642 may be configured as a general-purpose processor such as a microprocessor, but in the alternative, the general-purpose processor may be any processor, controller, microcontroller, or state machine suitable for carrying out processes of the present disclosure. The processor 642 may also be implemented as a combination of computing devices, such as a combination of a DSP and a microprocessor, a plurality of microprocessors, one or more microprocessors in conjunction with a DSP core, or any other such configuration.

A general-purpose processor may be part of a general-purpose computer. However, when configured to execute instructions (e.g., software code) for carrying out embodiments of the present disclosure the general-purpose computer should be considered a special-purpose computer. Moreover, when configured according to embodiments of the present disclosure, such a special-purpose computer improves the function of a general-purpose computer because, absent the present disclosure, the general-purpose computer would not be able to carry out the processes of the present disclosure. The processes of the present disclosure, when carried out by the special-purpose computer, are processes that a human would not be able to perform in a reasonable amount of time due to the complexities of the data processing, decision making, communication, interactive nature, or combinations thereof for the present disclosure. The present disclosure also provides meaningful limitations in one or more particular technical environments that go beyond an abstract idea. For example, embodiments of the present disclosure provide improvements in the technical field related to the present disclosure.

The memory 646 may be used to hold computing instructions, data, and other information for performing a wide variety of tasks including administering wagering games of the present disclosure. By way of example, and not limitation, the memory 646 may include Synchronous Random Access Memory (SRAM), Dynamic RAM (DRAM), Read-Only Memory (ROM), Flash memory, and the like.

The display 658 may be a wide variety of displays such as, for example, light-emitting diode displays, liquid crystal displays, cathode ray tubes, and the like. In addition, the display 658 may be configured with a touchscreen feature for accepting user input as a user interface element 644.

As non-limiting examples, the user interface elements 644 may include elements such as displays, keyboards, push-buttons, mice, joysticks, haptic devices, microphones, speakers, cameras, and touchscreens.

As non-limiting examples, the communication elements 656 may be configured for communicating with other devices or communication networks. As non-limiting examples, the communication elements 656 may include elements for communicating on wired and wireless communication media, such as, for example, serial ports, parallel ports, Ethernet connections, Universal Serial Bus (USB) connections, IEEE 1394 (“firewire”) connections, THUNDERBOLT™ connections, BLUETOOTH® wireless networks, ZigBee wireless networks, 802.11 type wireless networks, cellular telephone/data networks, and other suitable communication interfaces and protocols.

The storage 648 may be used for storing relatively large amounts of nonvolatile information for use in the computing system 640 and may be configured as one or more storage devices. By way of example and not limitation, these storage devices may include computer-readable media (CRM). This CRM may include, but is not limited to, magnetic and optical storage devices such as disk drives, magnetic tape, CDs (compact discs), DVDs (digital versatile discs or digital video discs), and semiconductor devices such as RAM, DRAM, ROM, EPROM, Flash memory, and other equivalent storage devices.

A person of ordinary skill in the art will recognize that the computing system 640 may be configured in many different ways with different types of interconnecting buses between the various elements. Moreover, the various elements may be subdivided physically, functionally, or a combination thereof. As one non-limiting example, the memory 646 may be divided into cache memory, graphics memory, and main memory. Each of these memories may communicate directly or indirectly with the one or more processors 642 on separate buses, partially combined buses, or a common bus.

As a specific, non-limiting example, various methods and features of the present disclosure may be implemented in a mobile, remote, or mobile and remote environment over one or more of Internet, cellular communication (e.g., Broadband), near field communication networks and other communication networks referred to collectively herein as an “iGaming environment.” The iGaming environment may be accessed through social media environments such as FACEBOOK® and the like. DragonPlay Ltd, acquired by Bally Technologies Inc., provides an example of a platform to provide games to user devices, such as cellular telephones and other devices utilizing ANDROID®, iPHONE® and FACEBOOK® platforms. Where permitted by jurisdiction, the iGaming environment can include pay-to-play (P2P) gaming where a player, from their device, can make value based wagers and receive value based awards. Where P2P is not permitted the features can be expressed as entertainment only gaming where players wager virtual credits having no value or risk no wager whatsoever such as playing a promotion game or feature.

An illustrative embodiment of information flow in an iGaming environment is detailed below. At a player level, the player or user accesses a site hosting the activity such as a website. The website may functionally provide a web game client. The web game client may be, for example, represented by a game client downloadable at information flow, which may process applets transmitted from a gaming server at information flow for rendering and processing game play at a player's remote device. Where the game is a P2P game, the gaming server may process value-based wagers (e.g., money wagers) and randomly generate an outcome for rendition at the player's device. In some embodiments, the web game client may access a local memory store to drive the graphic display at the player's device. In other embodiments, all or a portion of the game graphics may be streamed to the player's device with the web game client enabling player interaction and display of game features and outcomes at the player's device.

The website 700 may access a player-centric, iGaming-platform-level account module 704 at information flow 706 for the player to establish and confirm credentials for play and, where permitted, access an account (e.g., an eWallet) for wagering. The account module 704 may include or access data related to the player's profile (e.g., player-centric information desired to be retained and tracked by the host), the player's electronic account, deposit, and withdrawal records, registration and authentication information, such as username and password, name and address information, date of birth, a copy of a government issued identification document, such as a driver's license or passport, and biometric identification criteria, such as fingerprint or facial recognition data, and a responsible gaming module containing information, such as self-imposed or jurisdictionally imposed gaming restraints, such as loss limits, daily limits and duration limits. The account module 704 may also contain and enforce geo-location limits, such as geographic areas where the player may play P2P games, user device IP address confirmation, and the like.

The account module 704 communicates at information flow 705 with a game module 716 to complete log-ins, registrations, and other activities. The game module 716 may also store or access a player's gaming history, such as player tracking and loyalty club account information. The game module 716 may provide static web pages to the player's device from game module 716 through information flow 718, whereas, as stated above, the live game content may be provided from the gaming server 714 to the web game client through information flow 711.

The gaming server 714 may be configured to provide interaction between the game and the player, such as receiving wager information, game selection, inter-game player selections or choices to play a game to its conclusion, and the random selection of game outcomes and graphics packages, which, alone or in conjunction with the downloadable game client 708/web game client 702 and game module 716, provide for the display of game graphics and player interactive interfaces. At information flow 718, player account and log-in information may be provided to the gaming server 714 from the account module 704 to enable gaming. Information flow 720 provides wager/credit information between the account module 704 and gaming server 714 for the play of the game and may display credits and eWallet availability. Information flow 722 may provide player tracking information for the gaming server 714 for tracking the player's play. The tracking of play may be used for purposes of providing loyalty rewards to a player, determining preferences, and the like.

All or portions of the features of such an iGaming environment may be supported by servers and databases located remotely from a player's mobile device and may be hosted or sponsored by regulated gaming entity for P2P gaming or, where P2P is not permitted, for entertainment only play.

In some embodiments, wagering games may be administered without players risking money in connection with the wagers (i.e., “play-for-fun” games). Access to play-for-fun wagering games may be granted on a time period basis in some embodiments. For example, upon initially joining the wagering game, each player may automatically be given nonmonetary wagering elements, such as, for example, chips, points, or simulated currency, that are of no redeemable value. After joining, the player may be permitted to place bets using the wagering elements and a timer may track how long the player has been participating in the wagering game. If the player exhausts his or her supply of the wagering elements before a predetermined period of time has expired, the player may be permitted to simply wait until the period of time passes to rejoin the game, at which time access to another quantity of the wagering elements may be granted to the player to permit the player to resume participation in the wagering game.

In some embodiments, a hierarchy of players may determine the quantity of wagering elements given to a player for each predetermined period of time. For example, players who have been participating in the wagering game for a longer time, who have played closest to optimal strategy for the game, who have won the largest percentage of wagers, who have wagered the most in a play-for-pay environment, or who have won the largest quantities of wagering elements from their wagers may be given more wagering elements for each allotment of time than players who have newly joined, who have played according to poor strategy, who have lost more frequently, or who have lost larger quantities of wagering elements. In some embodiments, the hierarchy of players may determine the duration of each allotment of time. For example, players who have been participating in the wagering game for a longer time, who have played closest to optimal strategy for the game, who have won the largest percentage of wagers, or who have won the largest quantities of wagering elements from their wagers may be given shorter allotments of times to wait for an award of more wagering elements than players who have newly joined, who have played according to poor strategy, who have lost more frequently, or who have lost larger quantities of wagering elements. In some embodiments, players who have not run out of wagering elements after the period of time has expired may have the balance of their wagering elements reset for a subsequent allotment of time. In other embodiments, players who have not run out of wagering elements may be allowed to retain their remaining wagering elements for subsequent allotments of time, and may be given additional wagering elements corresponding to the new allotment of time to further increase the balance of wagering elements at their disposal. Players may be assigned to different categories of players, which determine the number of wagering elements awarded. In a given period of time, higher level players, or players who have invested more time playing the game may be allotted more wagering elements per unit of time than a player assigned to a lower level group.

Therefore, in some embodiments, the wagering game may be administered by receiving wagers (e.g., the ante wager and the additional tie wager) of no real-world monetary value, and payouts (e.g., the ante wager and the additional tie wager) may be paid without transferring real-world monetary value to the players. Such embodiments, referred to herein as “free play-for-fun” embodiments are nonetheless contemplated as modes of carrying out the methods described herein.

In some embodiments, referred to herein as “social play-for-fun” embodiments, a player may be permitted to redeem an access token of no redeemable face value, such as, for example, points associated with a player account (e.g., social media account credits, online points associated with a transacting account, etc.), to compress the period of time and receive more wagering elements. The access tokens may be sold or may be given without directly exchanging money for the access tokens. For example, access tokens may be allocated to players who participate in member events (e.g., complete surveys, receive training on how to play the wagering game, share information about the wagering game with others), spend time participating in the wagering game or in a player account forum (e.g., logged in to a social media account), or view advertising. Thus, an entity administering social play-for-fun wagering games may not receive money from losing player wagers or may not take a rake on wagers, but may receive compensation through advertising revenue or through the purchase of access tokens redeemable for time compressions to continue play of the wagering game or simply to increase the quantity of wagering elements available to a player.

After receipt of an indication that a player has stopped participating in a play-for-fun wagering game (e.g., a free play-for-fun embodiment, a social play-for-fun embodiment), any remaining quantities of the wagering elements may be relinquished by the player and retained by the administrator, in some embodiments. For example, receipt of an indication that the player has logged out of a play-for-fun wagering game administered over the Internet may cause any remaining wagering elements associated with a respective player to be lost. Thus, when the player rejoins the play-for-fun wagering game, the quantity of wagering elements given to the player for an allotment of time may not bear any relationship to the quantity of wagering elements held by the player when he or she quit playing a previous session of the wagering game. In other embodiments, upon receipt of an indication that a player has stopped playing, the quantity of wagering elements held by the player at that time may be retained and made available to the player, along with any additional quantities of wagering elements granted for new allotments of time, upon receipt of an indication that the player has rejoined the wagering game.

While certain illustrative embodiments have been described in connection with the figures, those of ordinary skill in the art will recognize and appreciate that embodiments encompassed by the disclosure are not limited to those embodiments explicitly shown and described herein. Rather, many additions, deletions, and modifications to the embodiments described herein may be made without departing from the scope of embodiments encompassed by the disclosure, such as those hereinafter claimed, including legal equivalents. In addition, features from one disclosed embodiment may be combined with features of another disclosed embodiment while still being within the scope of the disclosure, as contemplated by the inventors.

What is claimed is:

1. A method of administering a wagering game, the method comprising:
providing a processor programmed to enable one or more players to place ante wagers at one or more of a plurality of community hand positions, wherein each of the plurality of community hand positions is separate from each of the one or more players such that no player has the opportunity to affect the outcome of the plurality of community hand positions;
receiving, at the processor, an indication that at least one ante wager associated with a community hand position of the plurality of community hand positions to participate in the wagering game is accepted from a player;
receiving, at the processor, an indication that at least another ante wager associated with the community hand position to participate in the wagering game is accepted from another player;
determining, with the processor, a plurality of active community hand positions on which at least one wager has been received, the plurality of active community hand positions each exhibiting at least one randomized playing card from a set of playing cards;
determining, with the processor, a dealer hand position, the dealer hand position exhibiting at least another randomized playing card from the set of playing cards;
comparing a highest ranking playing card of each active community hand position of the plurality of active community hand positions with a highest ranking playing card of the dealer hand position; and
resolving, with the processor, the at least one ante wager and the at least another ante wager based on the comparison of the highest ranking card of the dealer hand position to the highest ranking card of at least one active community hand position of the plurality of active community hand positions.

2. The method of claim 1, further comprising receiving, at the processor, a selection from the player of at least two community hand positions of the plurality of community hand positions with which to associate at least two respective ante wagers.

3. The method of claim 1, further comprising, defining the plurality of active community hand positions to comprise one of three hand positions, five hand positions, or seven hand positions.

4. The method of claim 1, further comprising allocating at least one randomized playing card from the set of playing cards to each community hand position regardless of whether at least one ante wager is associated with the community hand position.

5. The method of claim 1, further comprising enabling the player to place an ante wager on at least two community hand positions of the plurality of community hand positions.

6. The method of claim 1, wherein the wagering game comprises two or more wagering games, each including the plurality of community hand positions, the method further comprising administering the two or more wagering games simultaneously with the processor.

7. The method of claim 1, further comprising, if the highest ranking card of the dealer hand position and the highest ranking card of at least one community hand position of the plurality of active community hand positions are equal, providing, at the processor, the player an opportunity to place an additional tie bet.

8. The method of claim 7, further comprising providing each of the dealer hand position and the at least one community hand position on which an additional tie bet has been received at least one additional playing card.

9. The method of claim 8, further comprising comparing a ranking of the at least one additional playing card of the dealer hand and of the at least one community hand position on which the additional tie bet has been received.

10. The method of claim 1, wherein:
determining the plurality of active community hand positions comprises dealing each of the plurality of active community hand positions on which at least one ante wager has been received at least one physical playing card from a set of physical playing cards; and
determining the dealer hand position comprises dealing the dealer hand position at least one physical playing card from the set of physical playing cards.

11. The method of claim 10, further comprising supplying cards from the set of physical playing cards with a live dealer.

12. The method of claim 11, further comprising providing a video image of the live dealer to each player participating in the wagering game.

13. The method of claim 1, further comprising providing each player of the one or more players a respective terminal on which to participate in the wagering game.

14. The method of claim 1, wherein determining the plurality of active community hand positions and the dealer hand position comprise allocating, with the processor, virtual cards to each of the plurality of active community hand positions on which at least one ante wager has been placed and to the dealer hand position.

15. The method of claim 14, further comprising displaying, with the processor, the virtual cards to the player on a video display.

16. A method of administering a wagering game, the method comprising:
providing a processor programmed to enable players to place ante wagers at a plurality of community hand positions;
receiving, at the processor, an indication that the ante wagers to participate in the wagering game is accepted from the players;
receiving, at the processor, an indication of at least one of a plurality of community hand positions associated with the ante wagers from the players;
dealing each of the plurality of community hand positions one physical playing card from a set of physical playing cards, wherein the one physical playing card of at least one of the plurality of community hand positions is not specific to any of the players;
dealing a dealer hand position one physical playing card from the set of physical playing cards;
comparing the one physical playing card of each community hand position of the plurality of community hand positions with the one physical playing card of the dealer hand position;
resolving, at the processor, the ante wagers based on the comparison of the one physical playing card of the dealer hand position to the one physical playing card of each community hand position of the plurality of community hand positions;
determining if the one physical playing card of the dealer hand position and the one physical playing card of at least one community hand position of the plurality of community hand positions are equal;
if the one physical playing card of the dealer hand position and the one physical playing card of at least one community hand position of the plurality of community hand positions are equal, providing, at the processor, at least one player of the players an opportunity to place an additional tie bet;
providing each of the dealer hand position and the least one community hand position that is equal to the dealer hand position one additional physical playing card;
comparing the one additional physical playing card of the at least one community hand position of the plurality of community hand positions with the one additional physical playing card of the dealer hand position; and
resolving, with the processor, the additional tie bet based on the comparison of the one additional physical playing card of the dealer hand position to the one additional physical playing card of the at least one community hand position of the plurality of community hand positions.

17. The method of claim 16, further comprising supplying physical playing cards from the set of physical playing cards with a live dealer.

18. The method of claim 17, further comprising displaying a video of the live dealer and the physical playing cards to the players participating in the wagering game.

19. The method of claim 16, further comprising enabling the at least one player to place an ante wager on each of at least three community hand positions of the plurality of community hand positions.

20. A method of administering a wagering game over a network utilizing a processor, the method comprising:
providing the processor programmed to enable a plurality of players to place a plurality of ante wagers at some or all of a plurality of community hand positions;
receiving, at the processor, an indication that the plurality of ante wagers to participate in the wagering game is accepted from the plurality of players;
receiving, at the processor, an indication of at least one of a plurality of community hand positions associated with each ante wager of the plurality of ante wagers from the plurality of players;
dealing each of the plurality of community hand positions at least one physical playing card from a set of physical playing cards, the one physical playing card of at least one of the plurality of community hand positions being disassociated with each of the plurality of players;
dealing a dealer hand position at least one physical playing card from the set of physical playing cards;
comparing the at least one physical playing card of each community hand position of the plurality of community hand positions with the at least one physical playing card of the dealer hand position; and
resolving, with the processor, the plurality of ante wagers based on the comparison of the at least one physical playing card of the dealer hand position to the at least one physical playing card of each community hand position of the plurality of community hand positions.
